(19) United States
(12) Patent Application Publication
(10) Pub. No.: US 2019/0205827 A1
(43) Pub. Date: Jul. 4, 2019

(54) STOCK MANAGEMENT DEVICE, ON-BOARD DEVICE AND STOCK MANAGEMENT METHOD

(71) Applicant: NEC Corporation, Minato-ku, Tokyo (JP)

(72) Inventors: Hiromi YAMAGUCHI, Tokyo (JP); Shinji NAKADAI, Tokyo (JP)

(73) Assignee: NEC Corporation, Minato-ku, Tokyo (JP)

(21) Appl. No.: 16/326,969

(22) PCT Filed: Aug. 22, 2017
(86) PCT No.: PCT/JP2017/029870

§ 371 Date: Feb. 21, 2019

(30) Foreign Application Priority Data
Aug. 23, 2016 (JP) 2016-162552

(51) Int. Cl. G06Q 10/08; G06Q 20/20; G06Q 50/30

(52) U.S. Cl. CPC G06Q 10/087; G06Q 50/30; G06Q 20/203

(57) ABSTRACT

Provide a stock management device capable of providing both a benefit of online shopping and a benefit by using a mobile sales vehicle. This stock management device is provided with: management means for managing stock information about stock of an item held by each of a plurality of mobile sales vehicles; first reception means for receiving, from each of the plurality of mobile sales vehicles, sales information indicating an item sold at a storefront of the mobile sales vehicle; second reception means for receiving, from a customer terminal, order information including information about an item ordered based on the stock information transmitted to the customer terminal; and transmission means for transmitting the order information to the mobile sales vehicle holding the ordered item included in the order information, wherein the management means updates the stock information based on at least one of the sales information and the order information.

### TECHNICAL FIELD

The present disclosure relates to a stock management device, an on-board device, an item sales system, a stock management method, a notification method, and a recording medium.

### BACKGROUND ART

There are an increasing number of customers doing online shopping to purchase an item through the Internet. Further, an item sales method called a mobile supermarket using a mobile sales vehicle has been proposed (NPL 1).

As a technology of combining the above, a technology of ordering, through a network, an item being sold by a mobile sales vehicle and purchasing the ordered item at a mobile sales vehicle is disclosed (PTL 1 and PTL 2).

Further, as a technology related to online shopping, for example, a method of supporting in-store picking of an item to be ordered is described in PTL 3.

Further, as a technology related to positional information of a moving vehicle, a method of specifying a delivery vehicle that can deliver a gas cylinder earliest to a customer, based on positional information of a delivery vehicle delivering a gas cylinder and positional information of the customer, and delivering a gas cylinder to the customer by the specified delivery vehicle is described in PTL 4.

### CITATION LIST

### Patent Literature

PTL 1: Japanese Unexamined Patent Application Publication No. 2011-221984
PTL 2: Japanese Unexamined Patent Application Publication No. 2008-123278
PTL 3: Japanese Unexamined Patent Application Publication No. 2009-151623
PTL 4: Japanese Unexamined Patent Application Publication No. 2002-334137

### Non Patent Literature

NPL 1: “Mobile Supermarket Tokushimaru,” [online], [retrieved on Jul. 13, 2016], retrieved from the Internet: <http://www.tokushimaru.jp/>

### SUMMARY OF INVENTION

### Technical Problem

Item purchase by online shopping takes at least several hours from ordering of an item to delivery to the purchaser, and therefore it takes a long time for actual delivery after ordering. However, in the case of item purchase by online shopping, for example, there is a benefit that a customer staying indoors can receive an item without going outdoors. Further, selling by a mobile sales vehicle, items are displayed on a luggage carrier of the mobile sales vehicle as is the case with a common supermarket, and therefore a customer can actually take an item in hand and purchase the item at the mobile sales vehicle. Accordingly, for example, when a supermarket does not exist close to a customer and a mobile sales vehicle sells items close to the customer, there is a benefit that the customer can get an item to be purchased at a storefront of the mobile sales vehicle, without visiting a distant supermarket. A technology allowing a customer to acquire both such a benefit of online shopping and such a benefit by using a mobile sales vehicle is being sought.

An object of the present disclosure is to provide a technology capable of providing both a benefit of online shopping and a benefit by using a mobile sales vehicle.

### Solution to Problem

A stock management device according to one aspect of the present disclosure includes:

management means for managing stock information about stock of an item held by each of a plurality of mobile sales vehicles;

first reception means for receiving, from each of the plurality of mobile sales vehicles, sales information indicating an item sold at a storefront of the mobile sales vehicle;

second reception means for receiving, from a customer terminal, order information including information about an item ordered based on the stock information transmitted to the customer terminal; and

transmission means for transmitting the order information to the mobile sales vehicle holding the ordered item included in the order information, wherein

the management means updates the stock information based on at least one of the sales information and the order information.

An on-board device according to one aspect of the present disclosure being loaded on each of a plurality of mobile sales vehicles, the on-board device includes:

reception means for receiving sellout information indicating that an item is sold out, from a stock management device managing stock information about stock of an item held by each of the plurality of mobile sales vehicles, when the item held by the mobile sales vehicle is sold out by an order from a customer terminal for the item held by the mobile sales vehicle; and

notification means for making notification that the item is sold out, based on the sellout information.

An item sales system according to one aspect of the present disclosure includes:

a stock management device;

an on-board device being loaded on each of a plurality of mobile sales vehicles and transmitting, to a stock management device, sales information indicating an item sold at a storefront of each of the plurality of mobile sales vehicles; and

one or more customer terminals, wherein

the stock management device includes:
management means for managing stock information about stock of an item held by each of the plurality of mobile sales vehicles;
first reception means for receiving the sales information;
second reception means for receiving, from the customer terminal, order information including information about an item ordered based on the stock information transmitted to the customer terminal; and
transmission means for transmitting the order information to the on-board device on the mobile sales vehicle holding the ordered item included in the order information, wherein

the management means updates the stock information based on at least one of the sales information and the order information.

A stock management method according to one aspect of the present disclosure includes:

managing stock information about stock of an item held by each of a plurality of mobile sales vehicles;

receiving, from each of the plurality of mobile sales vehicles, sales information indicating an item sold at a storefront of the mobile sales vehicle;

receiving, from a customer terminal, order information including information about an item ordered based on the stock information transmitted to the customer terminal; and

transmitting the order information to the mobile sales vehicle holding the ordered item included in the order information, wherein

updating the stock information based on at least one of the sales information and the order information.

A notification method according to one aspect of the present disclosure in an on-board device being loaded on each of a plurality of mobile sales vehicles, the notification method includes:

receiving sellout information indicating that an item is sold out, from a stock management device managing stock information about stock of an item held by each of the plurality of mobile sales vehicles, when the item held by the mobile sales vehicle is sold out by an order from a customer terminal for the item held by the mobile sales vehicle; and

making notification that the item is sold out, based on the sellout information.

A stock management method according to one aspect of the present disclosure in an item sales system including a stock management device, an on-board device loaded on each of a plurality of mobile sales vehicles, and one or more customer terminals, the stock management method includes:

managing, by the stock management device, stock information about stock of an item held by each of the plurality of mobile sales vehicles;

transmitting, by the on-board device, to a stock management device, sales information indicating an item sold at a storefront of a mobile sales vehicle loaded with the on-board device;

transmitting, by the customer terminal, to the stock management device, order information including information about an item ordered based on the stock information received from the stock management device;

receiving, by the stock management device, the sales information transmitted from the on-board device;

receiving, by the stock management device, the order information from the customer terminal;

transmitting, by the stock management device, the order information to the on-board device on the mobile sales vehicle holding the ordered item included in the order information; and

updating, by the stock management device, the stock information based on at least one of the sales information and the order information.

A computer program implementing the respective devices, system, or methods described above with a computer, and a computer-readable non-transitory recording medium storing the computer program are also included in the scope of the present disclosure.

### Advantageous Effects of Invention

The present disclosure can provide both a benefit of online shopping and a benefit by using a mobile sales vehicle.

### BRIEF DESCRIPTION OF DRAWINGS

FIG. 1 is a functional block diagram illustrating a functional configuration example of a stock management device according to a first example embodiment.

FIG. 2 is a flowchart illustrating an example of a processing flow in the stock management device according to the first example embodiment.

FIG. 3 is a functional block diagram illustrating a functional configuration example of an item sales system including the stock management device according to the first example embodiment.

FIG. 4 is a flowchart illustrating an example of a processing flow in the item sales system including the stock management device according to the first example embodiment.

FIG. 5 is a block diagram illustrating a configuration example of an item sales system according to a second example embodiment.

FIG. 6 is a diagram for illustrating a use scene of the item sales system according to the second example embodiment.

FIG. 7 is a functional block diagram illustrating a functional configuration example of a stock management device in the item sales system according to the second example embodiment.

FIG. 8 is a diagram illustrating an example of stock information stored by a stock information storage unit according to the second example embodiment.

FIG. 9 is a diagram illustrating an example of customer information stored by a customer information storage unit according to the second example embodiment.

FIG. 10 is a functional block diagram illustrating a functional configuration example of an on-board device in the item sales system according to the second example embodiment.

FIG. 11 is a functional block diagram illustrating a functional configuration example of a customer terminal in the item sales system according to the second example embodiment.

FIG. 12 is a diagram illustrating an example of an ordering screen displayed by a display unit.

FIG. 13 is a flowchart illustrating an example of a processing flow of updating stock information, based on sales information, in the item sales system according to the second example embodiment.

FIG. 14 is a flowchart illustrating an example of a flow of transmission processing of current position information by the on-board device in the item sales system according to the second example embodiment.

FIG. 15 is a flowchart illustrating an example of a flow of sales processing of an item by online shopping in the item sales system according to the second example embodiment.

FIG. 16 is a functional block diagram illustrating a functional configuration example of an on-board device according to a third example embodiment.

FIG. 17 is a diagram illustrating an example of a screen indicating that an item is sold out.

FIG. 18 is a diagram illustrating an example of a screen listing items sold by a mobile sales vehicle.

FIG. 19 is a flowchart illustrating an example of a processing flow in the on-board device according to the third example embodiment.

FIG. 20 is a functional block diagram illustrating a functional configuration example of an on-board device according to a modified example of the third example embodiment.

FIG. 21 is a flowchart illustrating an example of a processing flow in the on-board device according to the modified example of the third example embodiment.

FIG. 22 is a diagram exemplarily illustrating a hardware configuration of a computer (information processing device) capable of implementing the respective example embodiments.

### EXAMPLE EMBODIMENT

### First Example Embodiment

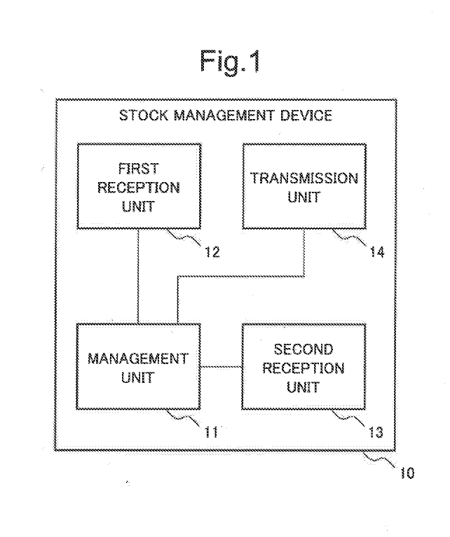

A first example embodiment of the present disclosure will be described with reference to drawings. A stock management device 10 managing stock information about stock of an item held by each of a plurality of mobile sales vehicles will be described in the present example embodiment. A mobile sales vehicle is a vehicle capable of moving to a predetermined location in accordance with a predetermined traveling route or in a predetermined area, and selling items loaded on a luggage carrier of the vehicle, at the destination. A mobile sales vehicle can also receive an order for an item loaded on the vehicle, while opening a luggage carrier and selling items loaded on the luggage carrier, or through a network while moving. Then, based on the received order, the mobile sales vehicle delivers the item to a customer who ordered. FIG. 1 is a functional block diagram illustrating a functional configuration example of the stock management device 10 according to the present example embodiment. As illustrated in FIG. 1, the stock management device 10 according to the present example embodiment includes a management unit 11, a first reception unit 12, a second reception unit 13, and a transmission unit 14.

The management unit 11 manages stock information about stock of an item held by each of a plurality of mobile sales vehicles. The stock information includes at least information (for example, an item name and an item identifier) for identifying an item held by each of the plurality of mobile sales vehicles and a quantity of the item. The management unit 11 manages stock information for each mobile sales vehicle. The stock information managed by the management unit 11 may be stored in a storage unit provided inside the stock management device 10 or may be stored in a storage device separate from the stock management device 10.

Further, the management unit 11 updates stock information, based on sales information received by the first reception unit 12 and/or order information received by the second reception unit 13.

The first reception unit 12 receives, from each of a plurality of mobile sales vehicles, sales information indicating an item sold at a storefront of the mobile sales vehicle. The sales information includes at least information (for example, an item name and an item identifier) for identifying an item sold at a storefront of a mobile sales vehicle, and a quantity of the item. The first reception unit 12 provides the received sales information to the management unit 11.

The second reception unit 13 receives from a customer terminal order information including information about an item ordered based on stock information transmitted to the customer terminal. The stock information may be transmitted by any unit or a component (unillustrated) transmitting the stock information. The order information includes at least information for identifying a customer ordering an item, information (for example, an item name and an item identifier) for identifying the ordered item, the item being included in the stock information managed by the management unit 11, and a quantity of the item. The second reception unit 13 provides the received order information to the management unit 11.

The transmission unit 14 transmits order information to a mobile sales vehicle holding an ordered item included in the order information. Specifically, the transmission unit 14 receives from the management unit 11 information indicating a mobile sales vehicle holding an ordered item included in order information along with the order information and transmits the order information to the mobile sales vehicle.

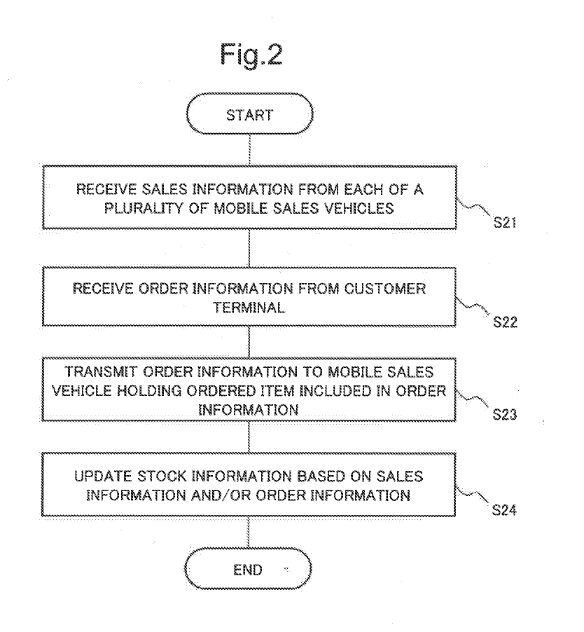

Next, a processing flow in the stock management device 10 according to the present example embodiment will be described with reference to FIG. 2. FIG. 2 is a flowchart illustrating an example of the processing flow in the stock management device 10 according to the present example embodiment. It is assumed in FIG. 2 that the management unit 11 in the stock management device 10 manages stock information about stock of an item held by a plurality of mobile sales vehicles, for each mobile sales vehicle. It is further assumed that the stock management device 10 transmits stock information to a customer terminal.

As illustrated in FIG. 2, first, the first reception unit 12 in the stock management device 10 receives, from each of a plurality of mobile sales vehicles, sales information indicating an item sold at a storefront of mobile sales vehicle (Step S21).

Further, the second reception unit 13 receives from a customer terminal order information including information about an item ordered based on stock information transmitted to the customer terminal from the stock management device 10 (Step S22). Steps S21 and S22 may be performed at a time or in reverse order.

When Step S22 ends, the transmission unit 14 transmits the order information to a mobile sales vehicle holding the ordered item included in the order information received in Step S22 (Step S23). Further, when Step S21 and/or Step S23 ends, the management unit 11 updates stock information, based on the sales information and/or the order information (Step S24). Specifically, when Step S21 ends, the management unit 11 updates stock information about stock held by a mobile sales vehicle transmitting sales information, based on the sales information. Further, when Step S23 ends, the management unit 11 updates stock information about stock held by a mobile sales vehicle to which the transmission unit 14 transmitted the order information, based on the order information.

The above concludes the processing by the stock management device 10.

As described above, the management unit 11 updates stock information based on at least one of sales information received by the first reception unit 12 and order information received by the second reception unit 13. The stock management device 10 manages both stock for mobile sale by a mobile sales vehicle and stock for an online shop. Thus, the stock management device 10, for example, reflects stock for mobile sale in which items sold by mobile sale to stock for an online shop. Further, for example, when an order for an item is placed by an online shop, stock information about stock of items available for sale at a mobile sales vehicle is also updated. Consequently, both a customer using a mobile sales vehicle and a customer doing online shopping can confirm items in stock purchasable at the time. Accordingly, items held by a mobile sales vehicle can be sold both at the mobile sales vehicle and on an online shop.

Further, the transmission unit 14 transmits order information to a mobile sales vehicle holding an ordered item included in the order information. Consequently, a driver of a mobile sales vehicle receiving the order information can deliver the item to a customer who ordered the item held by the mobile sales vehicle.

Accordingly, the stock management device 10 according to the present example embodiment can provide both a benefit of online shopping and a benefit by using a mobile sales vehicle.

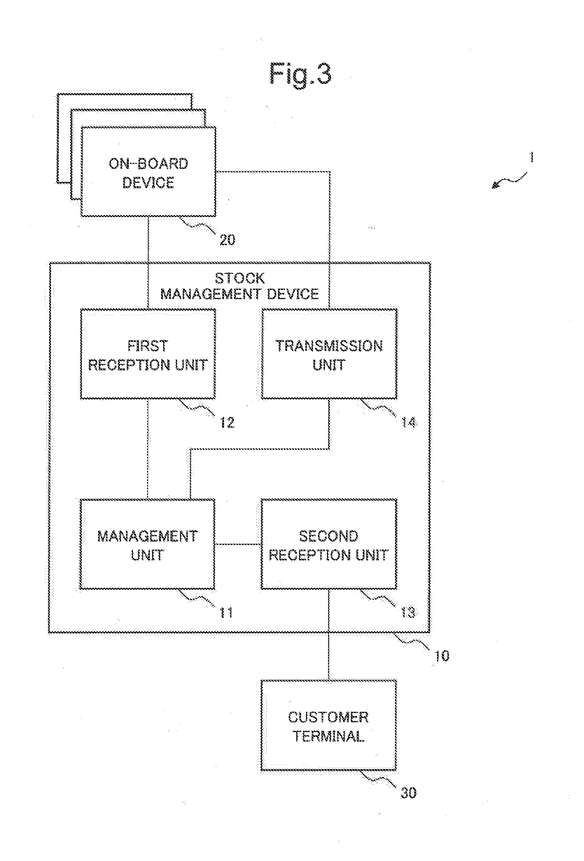

Further, an item sales system 1 including the stock management device 10 according to the present example embodiment will be described with reference to FIG. 3. FIG. 3 is a functional block diagram illustrating a functional configuration example of the item sales system 1 including the stock management device 10 according to the present example embodiment. As illustrated in FIG. 3, the item sales system 1 includes a stock management device 10, a plurality of on-board devices 20, and one or a plurality of customer terminals 30. The stock management device 10 included in FIG. 3 has a configuration similar to that of the stock management device 10 described by use of FIG. 1.

An on-board device 20 is loaded on each of a plurality of mobile sales vehicles and transmits to the stock management device 10 sales information indicating an item sold at a storefront of each of the plurality of mobile sales vehicles. A first reception unit 12 in the stock management device 10 receives the sales information.

Further, a second reception unit 13 in the stock management device 10 receives order information transmitted from each customer terminal 30.

A management unit 11 in the stock management device 10 updates stock information based on at least one of sales information received by the first reception unit 12 and order information received by the second reception unit 13.

Further, a transmission unit 14 transmits order information to an on-board device 20 on a mobile sales vehicle holding an ordered item included in the order information.

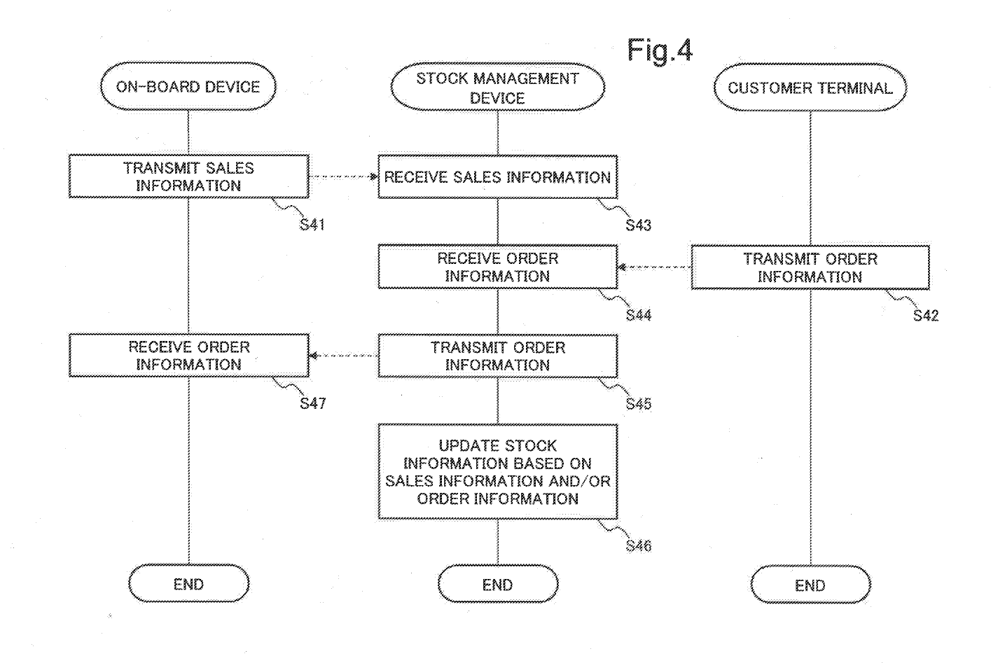

Next, a processing flow in the item sales system 1 including the stock management device 10 according to the present example embodiment will be described with reference to FIG. 4. FIG. 4 is a flowchart illustrating an example of the processing flow in the item sales system 1 including the stock management device 10 according to the present example embodiment. It is assumed in FIG. 4 that the management unit 11 in the stock management device 10 manages stock information about stock of an item held by a plurality of mobile sales vehicles, for each mobile sales vehicle. It is further assumed that the stock management device 10 transmits the stock information to a customer terminal 30. Further, in FIG. 4, processing by an on-board device 20 is described on the left, processing by the stock management device 10 at the center, and processing by a customer terminal 30 on the right; and a broken arrow between the respective processing steps represents a flow of primary information. An information flow is not limited to a direction of an arrow, and for example, an ACKnowledgement (ACK) may be transmitted in a direction reverse to the arrow.

As indicated in FIG. 4, an on-board device 20 transmits to the stock management device 10 sales information indicating an item sold at the storefront of the mobile sales vehicle loaded with the on-board device 20 (Step S41). Further, a customer terminal 30 transmits to the stock management device 10 order information including information about an item ordered based on the stock information received from the stock management device 10 (Step S42). Steps S41 and S42 are performed asynchronously, and an order thereof is not particularly limited.

When Step S41 ends, the first reception unit 12 in the stock management device 10 receives sales information indicating an item sold at the storefront from an on-board device 20 loaded on each of a plurality of mobile sales vehicles (Step S43). Further, when Step S42 ends, the second reception unit 13 in the stock management device 10 receives the order information from the customer terminal 30 (Step S44).

When Step S44 ends, the transmission unit 14 transmits the order information received in Step S44 to an on-board device 20 loaded on a mobile sales vehicle holding an ordered item included in the order information (Step S45). Further, when Step S43 and/or Step S44 ends, the management unit 11 updates the stock information, based on the sales information and/or the order information (Step S46). Specifically, when updating the stock information, based on the sales information, the management unit 11 updates the stock information about stock held by a mobile sales vehicle transmitting the sales information, based on the sales information. Further, when updating the stock information, based on the order information, the management unit 11 updates the stock information about stock held by a mobile sales vehicle to which the order information is transmitted by the transmission unit 14 in Step S45, based on the order information.

When Step S45 ends, the on-board device 20 receives the order information (Step S47). While the order information is transmitted to the on-board device 20 transmitting the sales information in FIG. 4, a destination of the order information is an on-board device 20 on a mobile sales vehicle holding the item included in the order information.

In the item sales system 1, when an item is purchased at a mobile sales vehicle loaded with an on-board device 20, Step S41 is executed again. Further, when an item is ordered by a customer terminal 30, Step S42 is executed again.

Thus, the stock management device 10 executes the processing illustrated in the flowchart in FIG. 4 every time a customer purchases an item.

As described above, in the item sales system 1, the management unit 11 in the stock management device 10 updates stock information, based on sales information received by the first reception unit 12 and order information received by the second reception unit 13. Further, the transmission unit 14 transmits order information to an on-board device 20 on a mobile sales vehicle holding an ordered item included in the order information. Consequently, the mobile sales vehicle loaded with the on-board device 20 can deliver the ordered item to a customer ordering the item.

Accordingly, the item sales system 1 including the stock management device 10 according to the present example embodiment can provide a customer with both a benefit of online shopping and a benefit by using a mobile sales vehicle.

### Second Example Embodiment

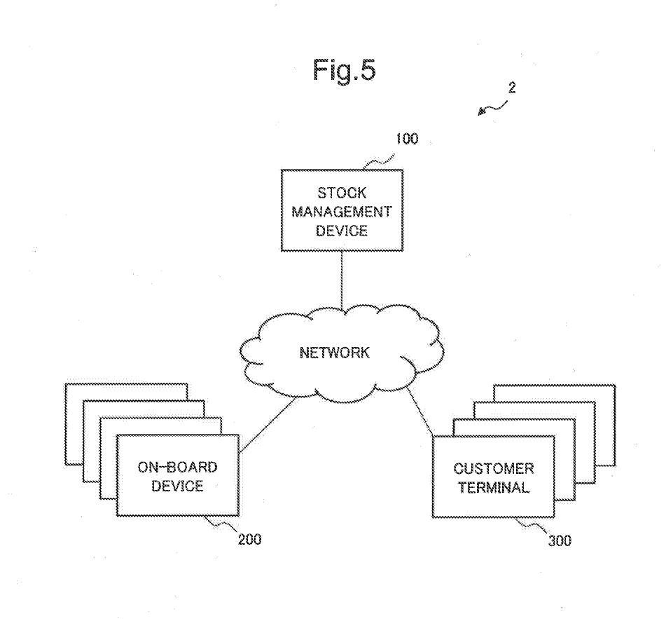

Next, a second example embodiment of the present disclosure based on the aforementioned first example embodiment will be described with reference to drawings. First, FIG. 5 illustrates a configuration example of an item sales system 2 according to the present example embodiment. As illustrated in FIG. 5, the item sales system 2 according to the present example embodiment includes a stock management device 100, a plurality of on-board devices 200, and one or a plurality of customer terminals 300. The stock management device 100 communicates with on-board devices 200 and customer terminals 300 through a network. A customer terminal 300 may be a mobile terminal or may be a desktop terminal.

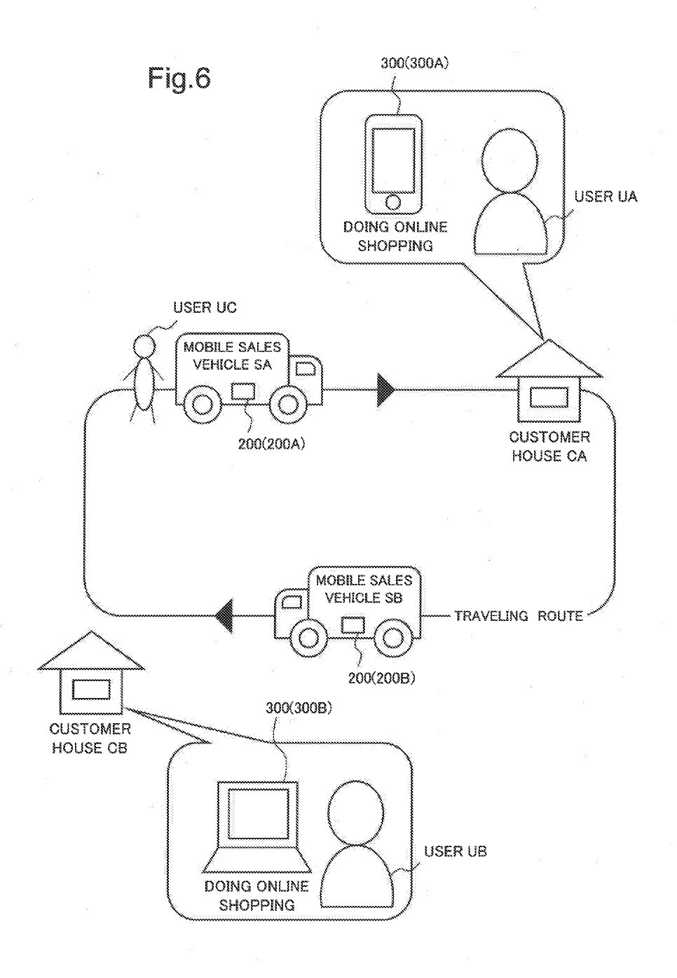

FIG. 6 is a diagram for illustrating a use scene of the item sales system 2 according to the present example embodiment. An on-board device 200 included in the item sales system 2 is a device loaded on each of a plurality of mobile sales vehicles. While FIG. 6 illustrates two mobile sales vehicles (SA, SB), a number of mobile sales vehicles may be three or more. Further, while an on-board device 200 loaded on the mobile sales vehicle SA is referred to as an on-board device 200A, and an on-board device 200 loaded on the mobile sales vehicle SB is referred to as an on-board device 200B, the devices are simply referred to as on-board devices 200 when the devices are not distinguished or referred to by a general name.

For example, each of the mobile sales vehicle SA and the mobile sales vehicle SB is a mobile-type supermarket traveling in accordance with a predetermined traveling route, stopping at a predetermined location, and selling a loaded item to a customer. The mobile sales vehicle may also be referred to as a mobile supermarket. Traveling routes according to which the plurality of mobile sales vehicles (SA, SB) travel may be identical, different, or partially overlapping one another.

It is assumed that a user UC is a customer using a mobile sales vehicle, according to the present example embodiment. It is further assumed that a user UA living in a customer house CA is a customer doing online shopping by use of a customer terminal 300A. It is further assumed that a user UB living in a customer house CB is a customer doing online shopping by use of a customer terminal 300B. The customer terminal 300A and the customer terminal 300B are simply referred to as customer terminals 300 when the terminals are not distinguished or referred to by a general name. The customer house CA and the customer house CB may be houses facing roads on the traveling routes of the mobile sales vehicles (SA, SB) or may be houses within a predetermined range from the traveling routes, respectively.

A store providing a service allowing a customer to do online shopping is hereinafter referred to as an online shop.

The item sales system 2 according to the present example embodiment provides both a customer using a mobile sales vehicle and a customer doing online shopping with benefits of using the respective means, by the stock management device 100 communicating with an on-board device 200 and a customer terminal 300.

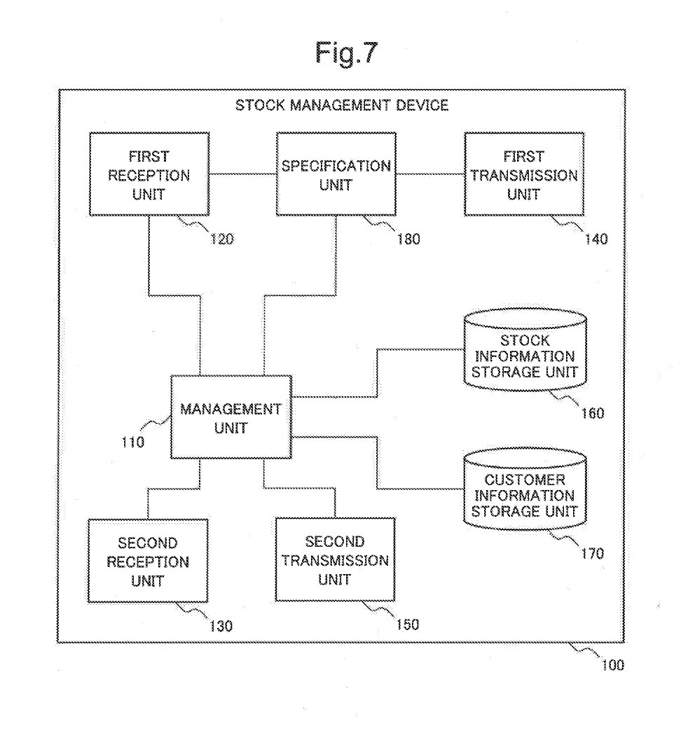

Next, a function of each device in the item sales system 2 according to the present example embodiment will be described in detail. FIG. 7 is a functional block diagram illustrating a functional configuration example of the stock management device 100 in the item sales system 2 according to the present example embodiment. As illustrated in FIG. 7, the stock management device 100 includes a management unit 110, a first reception unit 120, a second reception unit 130, a first transmission unit 140, a second transmission unit 150, a stock information storage unit 160, a customer information storage unit 170, and a specification unit 180.

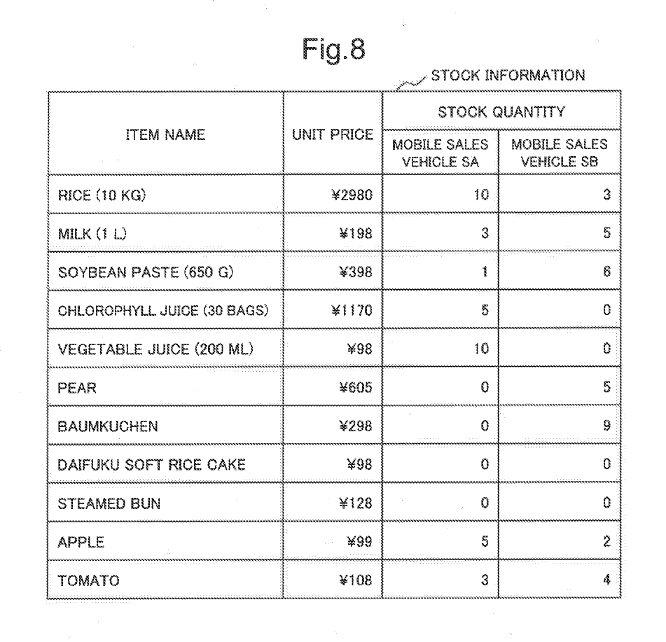

The stock information storage unit 160 stores stock information being information indicating stock of items held by each of a plurality of mobile sales vehicles. The stock information stored by the stock information storage unit 160 will be described with reference to FIG. 8. FIG. 8 is a diagram illustrating an example of stock information stored by the stock information storage unit 160 according to the present example embodiment. The stock information includes at least an item name being information for identifying an item held by each of a plurality of mobile sales vehicles, and a quantity of an item represented by the item name for each mobile sales vehicle. The stock information may include a unit price, as illustrated in FIG. 8. Information included in the stock information is not limited to the above.

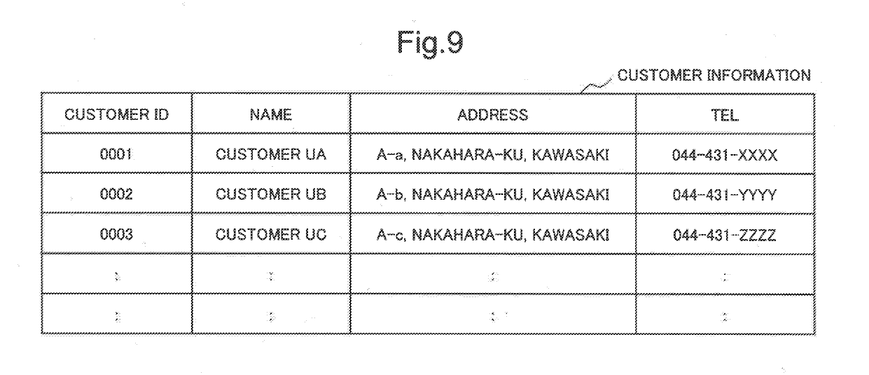

The customer information storage unit 170 stores customer information indicating information about a customer using a mobile sales vehicle and/or an online shop. The customer information stored by the customer information storage unit 170 will be described with reference to FIG. 9. FIG. 9 is a diagram illustrating an example of customer information stored by the customer information storage unit 170 according to the present example embodiment. The customer information includes a customer IDentifier (ID) for identifying a customer, a name of the customer, an address of the customer, and a telephone number of the customer. The customer information is not limited to the above and may include other information. Further, the customer information has only to include information by which a delivery address of an item can be identified. Further, for example, the customer information may include authentication information used for logging into an online shop. The customer information may be pre-registered when a service provided by the item sales system 2 is used. The registration method of the customer information is not particularly limited.

The stock information storage unit 160 and the customer information storage unit 170 may be implemented as separate storage units or may be implemented as the same storage unit. Further, the stock information storage unit 160 and the customer information storage unit 170 may be implemented as a storage device separate from the stock management device 100. Further, the stock information storage unit 160 and the customer information storage unit 170 may store stock information and customer information as databases, respectively.

The first reception unit 120 corresponds to the first reception unit 12 according to the first example embodiment. The first reception unit 120 receives from each of a plurality of mobile sales vehicles sales information indicating an item sold at its storefront. The sales information includes at least information (for example, an item name and an item identifier) for identifying an item sold at the storefront of the mobile sales vehicle and a quantity of the item. It is assumed below that the information for identifying an item is an item name. The first reception unit 120 provides the received sales information to the management unit 110 along with information (referred to as mobile sales vehicle information) indicating a mobile sales vehicle loaded with an on-board device 200 being a source of the sales information. The mobile sales vehicle information may be an identifier for identifying a mobile sales vehicle, a license plate number of the mobile sales vehicle, a vehicle identification number of the mobile sales vehicle, a model name of the mobile sales vehicle, or the like.

Additionally, the first reception unit 120 further receives current position information indicating current positions of a plurality of mobile sales vehicles. The first reception unit 120 provides received current position information to the specification unit 180 along with mobile sales vehicle information indicating a mobile sales vehicle loaded with an on-board device 200 transmitting the current position information.

The second reception unit 130 corresponds to the second reception unit 13 according to the first example embodiment. The second reception unit 130 receives from a customer terminal 300 order information including information about an item ordered based on stock information transmitted to the customer terminal 300. The order information includes at least information for identifying a customer ordering an item, information (for example, an item name and an item identifier) for identifying the ordered item, the item being included in stock information managed by the management unit 110, and a quantity of the item. The second reception unit 130 provides the received order information to the management unit 110. The order information received by the second reception unit 130 may include delivery address information indicating a delivery address designated by a customer.

The management unit 110 corresponds to the management unit 11 according to the first example embodiment. The management unit 110 manages stock information stored in the stock information storage unit 160. Further, the management unit 110 manages customer information stored in the customer information storage unit 170. Further, the management unit 110 may manage sales information and order information. The sales information and the order information may be stored and managed in a storage unit in the stock management device 100.

Information about stock items loaded on a mobile sales vehicle is registered in the stock information managed by the management unit 110 before each of a plurality of mobile sales vehicles starts mobile sale and also before the item being purchasable by online shopping. Then, the management unit 110 updates the stock information every time an item is purchased by mobile sale, every time an item is purchased by online shopping, and every time an item is carried in.

Further, the management unit 110 acquires, from the stock information storage unit 160, stock information to be transmitted to a customer terminal and provides the acquired stock information to the second transmission unit 150. At this time, the stock information acquired by the management unit 110 may be stock information about stock held by each of the mobile sales vehicles allowing a customer to purchase the items on an online shop at present, or may be stock information about stock held by mobile sales vehicles positioned within a predetermined range from a customer terminal, based on a position of the customer terminal. The mobile sales vehicle allowing a customer to purchase items on an online shop at present refers to, for example, a mobile sales vehicle capable of selling items on a luggage carrier at present, such as a mobile sales vehicle not being back in a garage, a mobile sales vehicle not all of items running out of stock, or a mobile sales vehicle not ending sale (not on the way back to a garage). Further, the stock information acquired by the management unit 110 may be, for example, stock information about stock held by a mobile sales vehicle positioned within a predetermined range from a delivery address when the delivery address is designated by a customer terminal. Further, the stock information acquired by the management unit 110 may be stock information about stock held by a mobile sales vehicle predesignated by a customer. Thus, the stock information acquired by the management unit 110 is not particularly limited.

Further, based on order information received by the second reception unit 130, the management unit 110 determines a candidate of a mobile sales vehicle (referred to as a delivery vehicle) delivering an item included in the order information. Specifically, the management unit 110 extracts a mobile sales vehicle holding an item included in the order information. For example, when order information includes “two apples,” the management unit 110 refers to stock information and determines a mobile sales vehicle holding two apples to be a delivery vehicle candidate. In the case of the stock information in FIG. 8, mobile sales vehicles holding two apples are the mobile sales vehicle SA and the mobile sales vehicle SB, and therefore the management unit 110 determines the mobile sales vehicle SA and the mobile sales vehicle SB to be delivery vehicle candidates.

Further, for example, when order information includes “three apples,” the management unit 110 refers to stock information and determines a mobile sales vehicle holding three apples as delivery vehicle candidates. In the case of the stock information in FIG. 8, a mobile sales vehicle holding three apples is the mobile sales vehicle SA only, and therefore the management unit 110 determines the mobile sales vehicle SA to be a delivery vehicle candidate. The management unit 110 provides the determined delivery vehicle candidate to the specification unit 180 along with the order information. When order information provided from the second reception unit 130 does not include delivery address information, the management unit 110 may refer to the customer information storage unit 170, include a customer address in the order information as delivery address information, and provide the resulting information to the specification unit 180.

Further, the management unit 110 updates stock information based on at least one of sales information and order information. For example, when sales information is transmitted from the on-board device 200 on the mobile sales vehicle SA, the management unit 110 updates stock information of the mobile sales vehicle SA, based on the sales information.

Further, when receiving from the specification unit 180 information indicating a delivery vehicle specified from delivery vehicle candidates provided to the specification unit 180 along with order information, the management unit 110 updates stock information of the delivery vehicle (mobile sales vehicle), based on the order information. For example, when a mobile sales vehicle specified as a delivery vehicle by the specification unit 180 is the mobile sales vehicle SA, the management unit 110 updates stock information of the mobile sales vehicle SA, based on related order information.

When a number of a delivery vehicle candidate is one, the management unit 110 may provide order information to the first transmission unit 140 instead of the specification unit 180. Then, the management unit 110 may update stock information, based on the order information.

Further, when an item of which quantity in stock becomes zero by updating stock information exists, the management unit 110 may transmit, to a mobile sales vehicle holding the item the stock quantity of which is zero sellout information indicating that the item held by the mobile sales vehicle is sold out.

The specification unit 180 receives delivery vehicle candidates from the management unit 110 along with order information. Further, the specification unit 180 receives current position information from the first reception unit 120 along with mobile sales vehicle information. Based on a current position of a mobile sales vehicle, the position being indicated by the current position information, and a position of a delivery address indicated by delivery address information included in the order information, the specification unit 180 specifies a mobile sales vehicle arriving earliest at the delivery address, out of mobile sales vehicles holding an ordered item. Specifically, the specification unit 180 confirms a current position of each of a plurality of mobile sales vehicles being the delivery vehicle candidates received from the management unit 110, based on the current position information. Then, the specification unit 180 compares the current position of each of the plurality of mobile sales vehicles with the position of the delivery address indicated by the delivery address information included in the order information and specifies a mobile sales vehicle arriving earliest at the delivery address as a delivery vehicle. The specification unit 180 may specify the delivery vehicle in consideration of information indicating whether or not a mobile sales vehicle is open for business, a storefront sales schedule, scheduled traveling route information, or the like. A mobile sales vehicle being open for business represents a state in which a mobile sales vehicle stops at a predetermined location, a luggage carrier is opened, and an item loaded on the vehicle is ready to be sold to a customer. For example, the information indicating whether or not a mobile sales vehicle is open for business may be based on a signal indicating that a luggage carrier of the mobile sales vehicle is opened, the signal being transmitted from an on-board device 200 to the stock management device 100. Further, a storefront sales schedule indicates where and when a mobile sales vehicle is scheduled to conduct mobile sale. The storefront sales schedule may be stored inside the stock management device 100 or may be transmitted from an on-board device 200. Further, scheduled traveling route information is information indicating a route on which a mobile sales vehicle is scheduled to travel. The scheduled traveling route information may be stored inside the stock management device 100 or may be transmitted from an on-board device 200. Further, the specification unit 180 may specify the delivery vehicle in consideration of a traveling direction of a mobile sales vehicle, road information at that point in time, and the like. The traveling direction of a mobile sales vehicle and the road information may be transmitted from an on-board device 200. The road information may be information indicating a traffic jam or may be information preset to a road, such as one-way traffic. Further, the road information may be transmitted from an external server managing road information. Then, the specification unit 180 provides information indicating the specified delivery vehicle to the first transmission unit 140 along with the order information. Further, the specification unit 180 provides the information indicating the specified delivery vehicle to the management unit 110.

The first transmission unit 140 corresponds to the transmission unit 14 according to the first example embodiment. The first transmission unit 140 transmits order information to a mobile sales vehicle holding an ordered item included in the order information. Specifically, the first transmission unit 140 receives from the specification unit 180 information indicating a specified delivery vehicle and order information. Then, the first transmission unit 140 transmits the order information to an on-board device 200 loaded on a mobile sales vehicle indicated by the information indicating the delivery vehicle.

The second transmission unit 150 receives stock information from the management unit 110. The second transmission unit 150 transmits the stock information to a customer terminal 300. For example, when a browser is activated on a customer terminal 300, the second transmission unit 150 may generate a screen including stock information and transmit the generated screen to the customer terminal 300. Further, for example, when an application is activated on a customer terminal 300, the second transmission unit 150 may transmit information including stock information to the customer terminal 300 in such a way that the application can display a screen including the stock information. When a customer terminal 300 can display a screen including stock information, the second transmission unit 150 may transmit stock information itself acquired by the management unit 110. It is preferable that a timing when the second transmission unit 150 transmits stock information to a customer terminal 300 be after detecting that a customer performs an operation for purchasing an item by use of the customer terminal 300. For example, detecting that a customer performs an operation for purchasing an item by use of the customer terminal 300 includes detecting that the stock management device 100 has received login information from a customer terminal 300 by the customer inputting the login information to the customer terminal 300 for logging into an online shop. Consequently, the customer using the customer terminal 300 can confirm stock information at a timing of logging into the online shop.

Further, every time stock information is updated, the second transmission unit 150 may further transmit the updated stock information to a customer terminal 300. Consequently, a customer using the customer terminal 300 can confirm latest stock information at a time of an update.

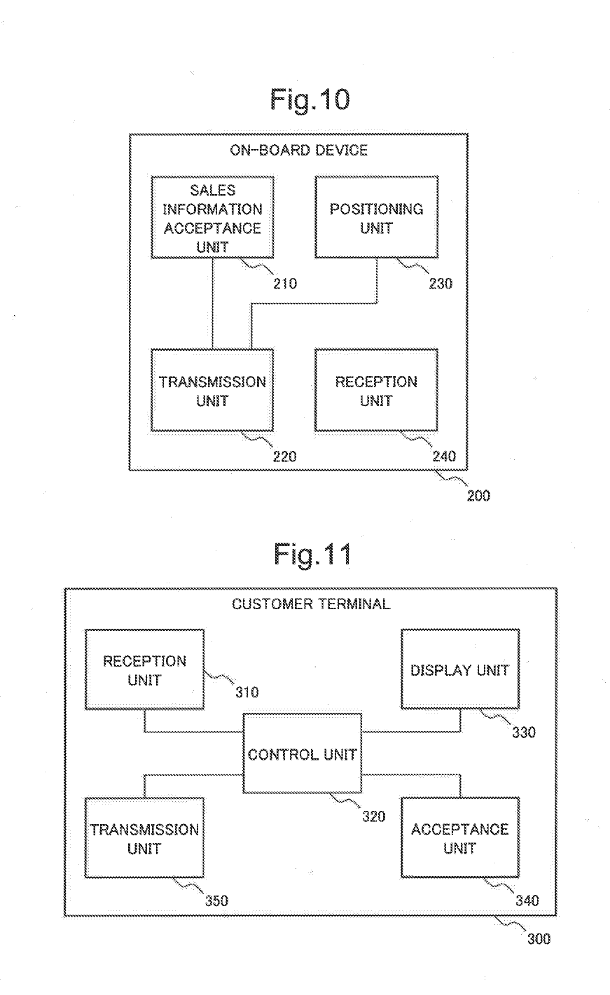

Next, a functional configuration of an on-board device 200 will be described with reference to FIG. 10. FIG. 10 is a functional block diagram illustrating a functional configuration example of an on-board device 200 in the item sales system 2 according to the present example embodiment. The on-board device 200 includes a sales information acceptance unit 210, a transmission unit 220, a positioning unit 230, and a reception unit 240.

The sales information acceptance unit 210 accepts sales information including an item name of an item sold by a mobile sale (an item purchased by a customer) of a mobile sales vehicle loaded with the on-board device 200, and a quantity of the item. For example, the sales information acceptance unit 210 is implemented with a point of sales (POS) register. The sales information acceptance unit 210 provides the accepted sales information to the transmission unit 220.

For example, the positioning unit 230 receives positional information by use of the Global Positioning System (GPS), and from the received positional information, measures a current position of a mobile sales vehicle loaded with the on-board device 200. A means used for measurement of a current position is not limited to the GPS. The positioning unit 230 may measure a current position by use of other information. The positioning unit 230 provides information (current position information) indicating a current position being a measurement result to the transmission unit 220.

When receiving sales information from the sales information acceptance unit 210, the transmission unit 220 transmits the sales information to the stock management device 100. Further, when receiving current position information from the positioning unit 230, the transmission unit 220 transmits the current position information to the stock management device 100.

The reception unit 240 receives order information transmitted from the stock management device 100. Consequently, a mobile sales vehicle loaded with the on-board device 200 receiving the order information can deliver an ordered item to a delivery address indicated by delivery address information, based on the order information.

Further, when sellout information is transmitted from the stock management device 100, the reception unit 240 may receive the sellout information. Consequently, a driver of a mobile sales vehicle loaded with the on-board device 200 or a customer using the mobile sales vehicle can understand that an item indicated by the sellout information is sold out.

Next, a functional configuration of a customer terminal 300 will be described with reference to FIG. 11. FIG. 11 is a functional block diagram illustrating a functional configuration example of a customer terminal 300 in the item sales system 2 according to the present example embodiment. As illustrated in FIG. 11, the customer terminal 300 includes a reception unit 310, a control unit 320, a display unit 330, an acceptance unit 340, and a transmission unit 350.

The reception unit 310 receives stock information from the stock management device 100. The stock information has only to include information required for displaying information about stock of an item held by a mobile sales vehicle on the display unit 330 and may be, for example, the stock information itself stored in the stock information storage unit 160, part of the stock information, or processed stock information. The reception unit 310 provides the received stock information to the control unit 320.

The display unit 330 displays a screen in accordance with an instruction by the control unit 320. For example, the display unit 330 is implemented with a liquid crystal display. The display unit 330 may be implemented with a display device separate from the customer terminal 300.

The acceptance unit 340 accepts an instruction from a user using the customer terminal 300. For example, the acceptance unit 340 accepts an instruction from a user input through an input device such as a mouse or a keyboard. The acceptance unit 340 provides the accepted instruction to the control unit 320.

The acceptance unit 340 and the display unit 330 may be integrally formed as a touch panel.

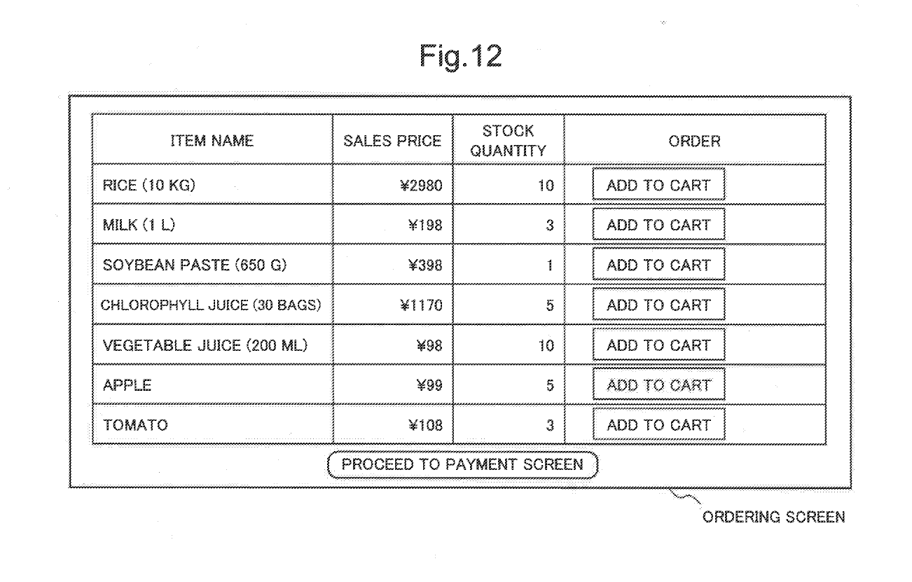

The control unit 320 controls the display unit 330 to display a screen based on the stock information received by the reception unit 310. A screen based on the stock information, the control unit 320 controlling the display unit 330 to display the screen, will be described with reference to FIG. 12. FIG. 12 is a diagram illustrating an example of a screen (ordering screen) displayed by the display unit 330.

It is assumed in the example in FIG. 12 that stock information about the mobile sales vehicle SA is solely transmitted to the customer terminal 300 from the stock management device 100. An ordering screen illustrated in FIG. 12 displays information about items held by the mobile sales vehicle SA, a stock quantity of each of which being one or more, out of the stock information illustrated in FIG. 8. Thus, the control unit 320 causes the display unit 330 to display a screen (ordering screen) based on stock information.

An “ADD TO CART” button in FIG. 12 is a button for accepting an instruction to add a relevant item to a cart on an online shop. In accordance with the instruction, the control unit 320 keeps information of the item added to the cart as cart information. The cart information includes information for identifying an item and a quantity of the item.

A “PROCEED TO PAYMENT SCREEN” button in FIG. 12 is a button for transition to a screen for making payment. A payment method can be selected on the payment screen. The payment method is not particularly limited, and therefore description is omitted in the present example embodiment. When an instruction to make payment is input, the acceptance unit 340 accepts the instruction. Then, in accordance with the instruction to make payment (that is, an instruction that the shopping is ended), the control unit 320 provides information kept as cart information and information for identifying a customer to the transmission unit 350 as order information.

When receiving order information from the control unit 320, the transmission unit 350 transmits the order information to the stock management device 100.

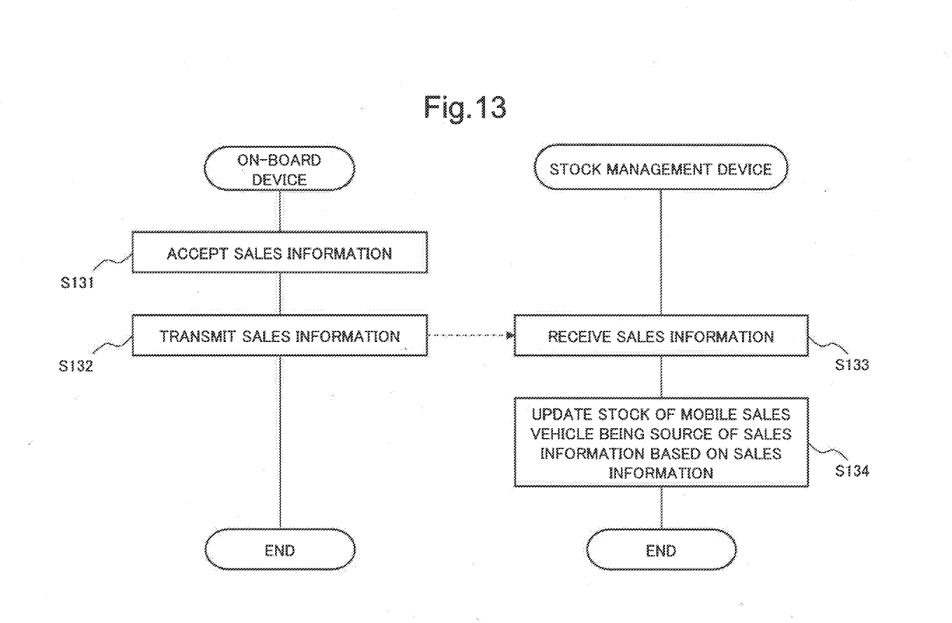

Next, processing of updating stock information, based on sales information, in the item sales system 2 will be described with reference to FIG. 13. FIG. 13 is a flowchart illustrating an example of a flow of the processing of updating stock information, based on sales information, in the item sales system 2 according to the present example embodiment.

It is assumed in FIG. 13 that the management unit 110 in the stock management device 100 manages stock information about stock of an item held by a plurality of mobile sales vehicles, for each mobile sales vehicle. Further, in FIG. 13, processing by an on-board device 200 is described on the left and processing by the stock management device 100 on the right; and a broken arrow between the respective processing steps represents a flow of primary information. An information flow is not limited to a direction of an arrow, and for example, an ACK may be transmitted in a direction reverse to the arrow.

First, the sales information acceptance unit 210 in the on-board device 200 accepts sales information including an item name of an item sold by a mobile sale (an item purchased by a customer) of a mobile sales vehicle loaded with the on-board device 200, and a quantity of the item (Step S131). Then, the transmission unit 220 transmits the sales information to the stock management device 100 (Step S132).

The first reception unit 120 in the stock management device 100 receives the sales information transmitted from the on-board device 200 (Step S133). The first reception unit 120 provides the sales information to the management unit 110 along with mobile sales vehicle information.

Based on the sales information provided from the first reception unit 120, the management unit 110 updates stock information about stock held by the mobile sales vehicle specified by the mobile sales vehicle information transmitted along with the sales information (Step S134).

The above concludes the processing of updating stock information based on sales information.

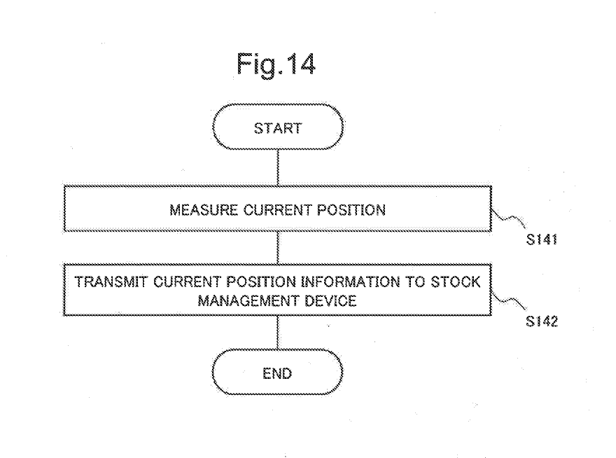

Next, transmission processing of current position information by an on-board device 200 will be described with reference to FIG. 14. FIG. 14 is a flowchart illustrating an example of a flow of the transmission processing of current position information by an on-board device 200 in the item sales system 2 according to the present example embodiment. The processing illustrated in FIG. 14 is performed asynchronously with the processing of updating stock information illustrated in FIG. 13.

As described in FIG. 14, the positioning unit 230 measures a current position (Step S141). The positioning unit 230 provides current position information being the measurement result to the transmission unit 220. Then, the transmission unit 220 transmits the current position information to the stock management device 100 (Step S142).

The above concludes the transmission processing of current position information by an on-board device 200.

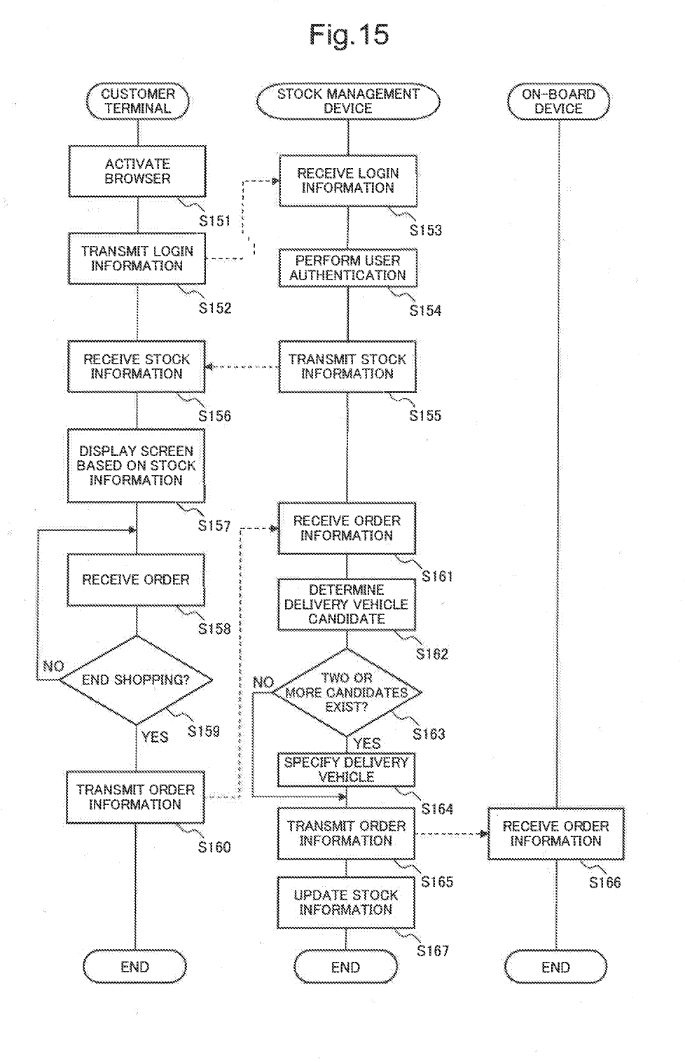

Next, sales processing of an item by online shopping in the item sales system 2 will be described with reference to FIG. 15. FIG. 15 is a flowchart illustrating an example of a flow of the sales processing of an item by online shopping in the item sales system 2 according to the present example embodiment. The processing illustrated in FIG. 15 is performed asynchronously with the processing of updating stock information illustrated in FIG. 13 and the transmission processing of current position information illustrated in FIG. 14.

In FIG. 15, processing by a customer terminal 300 is described on the left, processing by the stock management device 100 at the center, and processing by an on-board device 200 on the right; and a broken arrow between the respective processing steps represents a flow of primary information. An information flow is not limited to a direction of an arrow, and for example, an ACK may be transmitted in a direction reverse to the arrow.

A user (customer) using a customer terminal 300 inputs an instruction to start online shopping into the customer terminal 300, and the acceptance unit 340 accepts a content of the instruction. For example, when an instruction to activate a browser is input in order to do online shopping, the control unit 320 activates the browser (Step S151). For example, when processing accepted by the acceptance unit 340 is an instruction to activate an application for doing online shopping, the control unit 320 activates the application installed on the customer terminal 300.

Then, the transmission unit 350 transmits information required for doing online shopping to the stock management device 100. For example, the transmission unit 350 transmits to the stock management device 100 login information, such as a customer ID and authentication information for logging into an online shop (Step S152). The login information may be input by a customer for each shopping.

When receiving the login information transmitted from the customer terminal 300 (Step S153), the second reception unit 130 in the stock management device 100 transmits the login information to the management unit 110. Then, the management unit 110 refers to the customer information storage unit 170 and performs user authentication (Step S154). The user authentication may use any method, and therefore description is omitted in the present example embodiment.

Subsequently, when the customer is authenticated, the management unit 110 acquires stock information stored in the stock information storage unit 160 and provides the acquired stock information to the second transmission unit 150. The second transmission unit 150 transmits the stock information provided from the management unit 110 to the customer terminal 300 transmitting the login information to the stock management device 100 (Step S155). A timing of transmission of the stock information by the second transmission unit 150 may be after the stock management device 100 receives a transmission instruction of the stock information from the customer terminal subsequently to performing the user authentication. The timing of transmission of the stock information by the second transmission unit 150 has only to be after detection of the customer starting shopping on an online shop by use of the customer terminal 300 (performing an operation for purchasing an item by use of the customer terminal 300) such as after the stock management device 100 receives the aforementioned transmission instruction of the stock information. Further, the item sales system 2 may be configured not to perform user authentication.

The reception unit 310 in the customer terminal 300 receives the stock information from the stock management device 100 (Step S156). Subsequently, the control unit 320 causes the display unit 330 to display a screen based on the received stock information (Step S157). Subsequently, by use of the screen displayed based on the stock information, the customer orders an item. For example, when the customer depresses an “ADD TO CART” button illustrated in FIG. 12, the customer terminal 300 receives an order of an item by the customer, by the acceptance unit 340 accepting the depression of the button (Step S158). Subsequently, when an instruction to end the shopping (an instruction to make payment) is input by the customer, the acceptance unit 340 accepts the instruction to end the shopping (YES in Step S159). The acceptance unit 340 repeats Steps S158 and S159 until accepting an instruction to end the shopping. Then, the transmission unit 350 transmits order information to the stock management device 100 (Step S160).

The second reception unit 130 in the stock management device 100 receives the order information from the customer terminal 300 (Step S161). Based on the order information received by the second reception unit 130, the management unit 110 determines a candidate of a delivery vehicle delivering an item included in the order information, out of a plurality of mobile sales vehicles (Step S162).

The specification unit 180 determines whether or not a number of the delivery vehicle candidates determined in Step S161 is two or more (Step S163), and when the number is one (NO in Step S163), specifies a mobile sales vehicle determined to be the delivery vehicle candidate as the delivery vehicle and advances the processing to Step S165.

When the number of the delivery vehicle candidates determined in Step S162 is two or more (YES in Step S163), the specification unit 180 specifies a delivery vehicle delivering an item, out of a plurality of mobile sales vehicles determined to be the delivery vehicle candidates (Step S164). For example, based on a current position of a mobile sales vehicle, the position being indicated by current position information, and a position of a delivery address indicated by delivery address information, the specification unit 180 specifies a mobile sales vehicle arriving earliest at the delivery address as the delivery vehicle, out of mobile sales vehicles (delivery vehicle candidates) holding the ordered item.

The first transmission unit 140 transmits the order information to the delivery vehicle specified by the specification unit 180 (Step S165). Specifically, the first transmission unit 140 transmits the order information to an on-board device 200 loaded on the delivery vehicle specified by the specification unit 180.

Then, the reception unit 240 in the on-board device 200 to which the order information is transmitted receives the order information transmitted from the stock management device 100 (Step S166).

Further, the management unit 110 in the stock management device 100 updates the stock information, based on the order information (Step S167). Step S167 may be performed prior to Step S165 or may be performed at a time with Step S165.

The above concludes the sales processing of an item by online shopping by the item sales system 2.

As described above, the management unit 110 in the stock management device 100 in the item sales system 2 according to the present example embodiment manages stock information about stock of an item held by each of a plurality of mobile sales vehicles. Further, the first reception unit 120 receives sales information indicating an item sold at a storefront of a mobile sales vehicle from an on-board device 200 loaded on each of the plurality of mobile sales vehicles. Further, the second reception unit 130 receives from a customer terminal 300 order information including information about an item ordered based on stock information transmitted to the customer terminal 300. Additionally, the first transmission unit 140 transmits order information to an on-board device 200 loaded on a mobile sales vehicle holding an ordered item included in the order information. Consequently, a mobile sales vehicle loaded with the on-board device 200 receiving the order information can deliver the ordered item to a customer ordering the item.

Furthermore, the specification unit 180 specifies a mobile sales vehicle arriving earliest at a delivery address as a delivery vehicle, out of mobile sales vehicles holding an ordered item, and the first transmission unit 140 transmits order information to the specified delivery vehicle. Consequently, a mobile sales vehicle loaded with an on-board device 200 receiving the order information can be considered a mobile sales vehicle arriving earliest at the delivery address. Accordingly, the ordered item can be more quickly delivered to a customer doing online shopping.

Further, since an on-board device 200 receives order information, a driver of a mobile sales vehicle loaded with the on-board device 200 can understand items available for actual sale out of items held by the mobile sales vehicle.

Further, the management unit 110 updates stock information based on at least one of sales information and order information. A customer doing online shopping places an order based on stock information. Accordingly, a customer doing online shopping can confirm an item in stock at the time of performing the online shopping (purchasable item), and therefore can purchase a desired item.

Accordingly, the item sales system 2 according to the present example embodiment can provide a customer with both a benefit of online shopping and a benefit by using a mobile sales vehicle.

### Third Example Embodiment

Next, a third example embodiment will be described. A method for unitarily managing stock of an item being sold at a mobile sales vehicle and stock of an item being sold on an online shop has been described in the first and second example embodiments. By thus unitarily management of stock as described above, there is a possibility that an item actually held by a mobile sales vehicle is already purchased on an online shop. At this time, in case that the mobile sales vehicle sells the item, there is a possibility that the item is not delivered to a customer purchased the item by use of the online shop. A technology of preventing an item already purchased on an online shop from being purchased at a mobile sales vehicle will be described below.

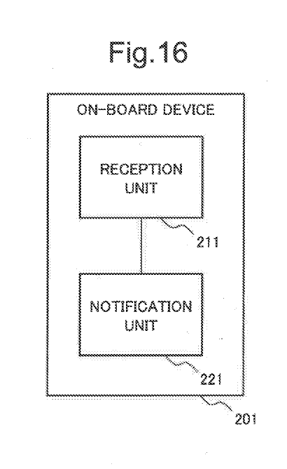

FIG. 16 is a functional block diagram illustrating a functional configuration example of an on-board device 201 according to the present example embodiment. As illustrated in FIG. 16, the on-board device 201 includes a reception unit 211 and a notification unit 221. An item sales system including the on-board device 201 according to the present example embodiment may include the on-board device 201 in place of or in addition to the on-board device 200 in the item sales system 2 described by use of FIG. 5. The on-board device 201 may be integrally formed with the on-board device 200. In other words, the on-board device 200 according to the aforementioned second example embodiment may be configured to further include the reception unit 211 and the notification unit 221. In this case, the reception unit 240 and the reception unit 211 may be configured as a single reception unit.

The reception unit 211 receives, from the aforementioned stock management device 100, sellout information indicating that an item is sold out when the item held by a mobile sales vehicle is sold out by an order from a customer terminal 300 for the item held by the mobile sales vehicle. The sellout information indicates that an item is sold out and includes information (for example, an item name and an item identifier) for identifying an item. The reception unit 211 provides the received sellout information to the notification unit 221.

When receiving sellout information from the reception unit 211, the notification unit 221 makes notification that an item indicated by the sellout information is sold out based on the sellout information.

Specifically, the notification unit 221 makes notification in an understandable manner for a driver of a mobile sales vehicle that an item is sold out. For example, the notification unit 221 notifies the driver that an item is sold out, by displaying a name of the sold-out item on a display device visually recognizable to the driver. Consequently, the driver of the mobile sales vehicle can understand that the item held by the mobile sales vehicle is sold out. For example, it is assumed that, in a state that a mobile sales vehicle SA holds three tomatoes, the three tomatoes are already purchased on an online shop. In this case, the reception unit 211 in an on-board device 200 loaded on the mobile sales vehicle SA receives sellout information for the tomatoes. Accordingly, a driver of the mobile sales vehicle SA can understand that the tomatoes held by the mobile sales vehicle SA already sold on the online shop and are actually sold-out. Accordingly, the driver of the mobile sales vehicle SA can take a measure of not selling the tomatoes at the mobile sales vehicle SA.

Further, when a mobile sales vehicle includes a display device visually recognizable to a customer, the notification unit 221 notifies a customer that an item is sold out, by displaying a screen indicating that the item is sold out on the display device.

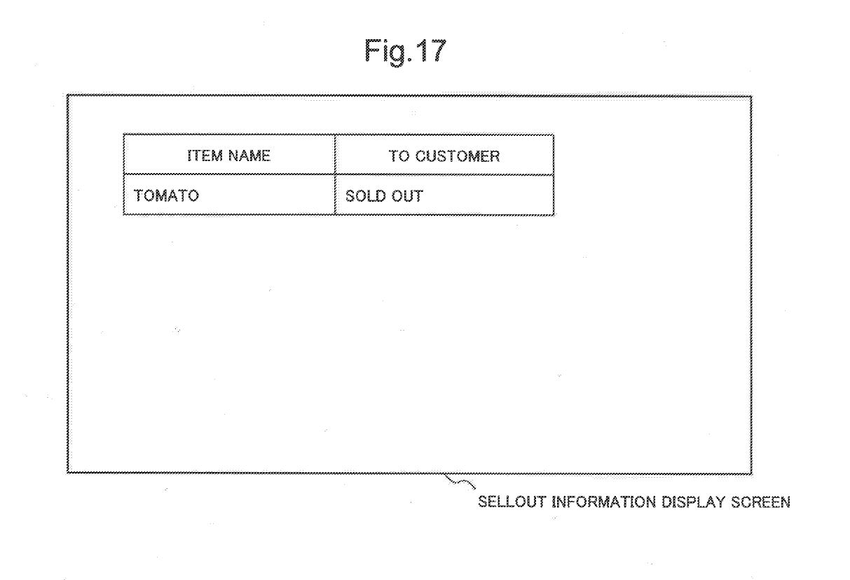

The above will be described with reference to FIG. 17. FIG. 17 is a diagram illustrating an example of a screen (sellout information display screen) indicating that an item is sold out. As illustrated in FIG. 17, the notification unit 221 displays information indicating a sold-out item on a screen, based on sellout information received by the reception unit 211.

Consequently, a customer of a mobile sales vehicle loaded with the on-board device 200 can readily understand that the item indicated by the sellout information is sold out.

Further, an on-board device 201 may manage stock information about stock of items held at the time by a mobile sales vehicle loaded with the on-board device 201. Additionally, the stock management device 100 may transmit to an on-board device 201 stock information about stock held by a mobile sales vehicle loaded with the on-board device 201. Then, the reception unit 211 may receive the stock information.

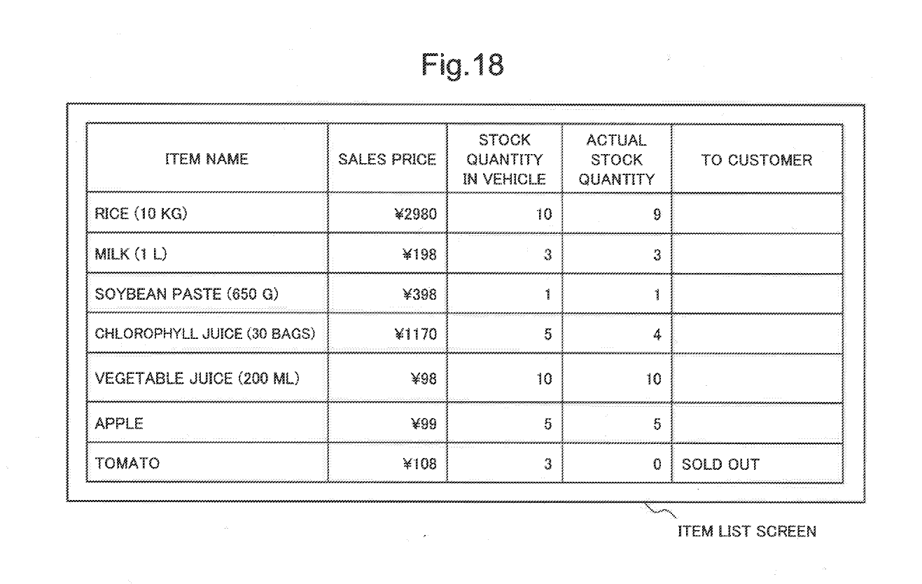

In this case, for example, the notification unit 221 may display an item list screen as illustrated in FIG. 18. The item list screen illustrated in FIG. 18 includes information (for example, an item name, a sales price, and a stock quantity in the vehicle) about a stock managed by the on-board device 201, stock information (an actual stock quantity) managed by the stock management device 100, and sellout information. Further, the notification unit 221 may display information about an item purchased on an online shop, in place of stock information.

Further, the notification unit 221 may notify a customer of a sold-out item by a sound.

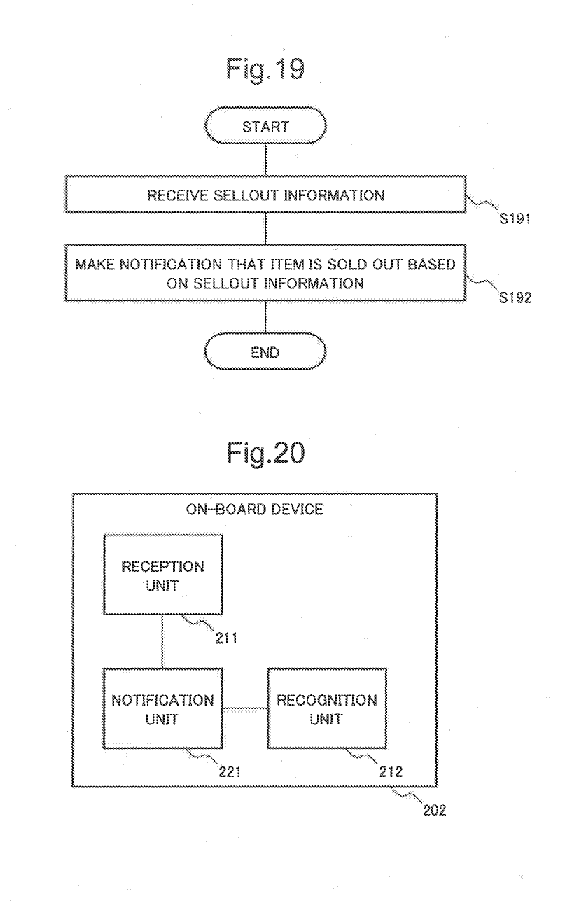

FIG. 19 is a flowchart illustrating an example of a processing flow in an on-board device 201 according to the present example embodiment. As described in FIG. 19, when an item held by a mobile sales vehicle is sold out by an order placed for the item held by the mobile sales vehicle from a customer terminal, the reception unit 211 receives from the stock management device sellout information indicating that the item is sold out (Step S191).

Then, the notification unit 221 makes notification that the item is sold out, based on the sellout information (Step S192).

The on-board device 201 repeats aforementioned Steps S191 and S192 every time sellout information is transmitted from the stock management device 100.

As described above, when an item of which a customer is considering purchase is already purchased on an online shop, an on-board device 201 according to the present example embodiment can notify the customer that the item is not purchasable. Accordingly, the customer can readily understand whether or not an item taken in the customer's hand is purchasable.

A system including an on-board device 201 with a configuration as described above can sell items held by a mobile sales vehicle to either a customer doing online shopping or a customer using a mobile sales vehicle.

Further, when a customer wants to purchase a sold-out item, a mobile sales vehicle may deliver the item to the customer. When a delivery address is not stored in the customer information storage unit 170, the address may be learned from the customer on the spot and be registered. Thus, even for a customer not being able to purchase an item, a mobile sales vehicle can provide a service of delivering the item to the customer since a store selling items is not a stationary store.

### Modified Example

A modified example of the present example embodiment will be described with reference to drawings. Another example of a notification method in the notification unit 221 will be described in this modified example. FIG. 20 is a diagram illustrating a functional configuration example of an on-board device 202 according to this modified example. As illustrated in FIG. 20, the on-board device 202 according to this modified example includes a reception unit 211, a notification unit 221, and a recognition unit 212. The on-board device 202 has a configuration of the on-board device 201 further including the recognition unit 212.

The on-board device 202 according to this modified example may be integrally formed with the aforementioned on-board device 200, similarly to the on-board device 201. In other words, the on-board device 200 according to the aforementioned second example embodiment may have a configuration further including the reception unit 211, the notification unit 221, and the recognition unit 212. In this case, the reception unit 240 and the reception unit 211 may be configured as a single reception unit.

The recognition unit 212 recognizes an item of which a customer using a mobile sales vehicle is considering purchase. For example, when a customer takes an item in hand, in order to purchase the item, from a shelf displaying items, the recognition unit 212 recognizes the item taken in the customer's hand, from an image captured by an imaging device. Further, when a customer puts an item into a shopping basket, the recognition unit 212 recognizes the item put into the shopping basket by the customer, from an image capturing a content of the shopping basket. Further, when a sensor detecting that an item is taken out is installed on a shelf displaying items, the recognition unit 212 recognizes the item which has been taken out, based on a detection result of the sensor. Thus, the method of recognizing an item by the recognition unit 212 is not particularly limited. The recognition unit 212 provides the recognition result to the notification unit 221.

The notification unit 221 determines whether or not the recognized item is sold out, based on the recognition result provided from the recognition unit 212. Then, when determining that the recognized item is sold out, the notification unit 221 makes notification in an understandable manner for the customer that the item of which the customer is considering purchase is sold out. For example, the notification unit 221 notifies the customer that the item is sold out by a sound or an alarm such as a buzzer.

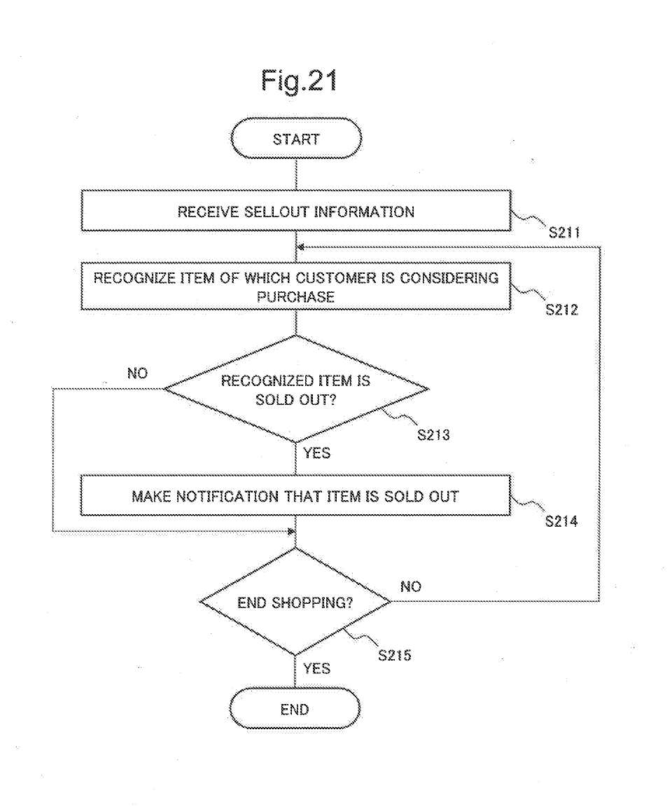

FIG. 21 is a flowchart illustrating an example of a processing flow in an on-board device 202 according to the present example embodiment. As described in FIG. 21, when an item held by a mobile sales vehicle becomes sold out by an order placed for the item held by the mobile sales vehicle from a customer terminal, the reception unit 211 receives from the stock management device sellout information indicating that the item is sold out (Step S211).

The recognition unit 212 recognizes an item of which a customer using a mobile sales vehicle is considering purchase (Step S212). Steps S211 and S212 may be performed at a time or may be performed in reverse order.

After Steps S211 and S212 end, the notification unit 221 determines whether or not the item recognized by the recognition unit 212 is sold out, based on the sellout information (Step S213). When the notification unit 221 determines that the item recognized by the recognition unit 212 is not sold out (NO in Step S213), the on-board device 202 advances the processing to Step S215. When the notification unit 221 determines that the item recognized by the recognition unit 212 is sold out (YES in Step S213), the notification unit 221 makes notification that the item is sold out (Step S214). Then, the on-board device 202 determines whether the customer ends the shopping (Step S215). The determination of the customer ending the shopping is made by detecting the customer leaving the mobile sales vehicle or the customer bringing an item to a checkout counter. Then, the on-board device 202 repeats Steps S212 to S214 until the customer ends the shopping, and when the customer ends the shopping, ends the processing.

Further, the on-board device 202 repeats aforementioned Steps S211 to S215 every time sellout information is transmitted from the stock management device 100.

The on-board device 202 may include a device for detecting an item of which a customer is considering purchase. In other words, the on-board device 202 may be configured to include the aforementioned imaging device, sensor, and the like.

As described above, when an item of which a customer is considering purchase is already purchased on an online shop, the on-board device 202 according to this modified example can notify the customer that the item cannot be purchased. Accordingly, a customer can readily understand whether or not an item taken in the customer's hand is purchasable.

Further, when a customer takes an item in hand a quantity of which is greater than an actual stock quantity, the notification unit 221 may make notification in an understandable manner for the customer that the item is sold out. For example, it is assumed that, in a state that a mobile sales vehicle SA holds three tomatoes, two tomatoes are already purchased on an online shop. In this case, the number of tomatoes available for actual sale is one, and therefore when a customer takes two or more tomatoes in hand, the notification unit 221 makes notification in an understandable manner for the customer that only one tomato is vendible. For example, when a customer takes two tomatoes in hand, the notification unit 221 may issue a warning sound or display a notification on a screen indicating that only one tomato is vendible. Such a configuration also allows a customer to readily understand whether or not an item taken in the customer's hand is purchasable.

### About Hardware Configuration

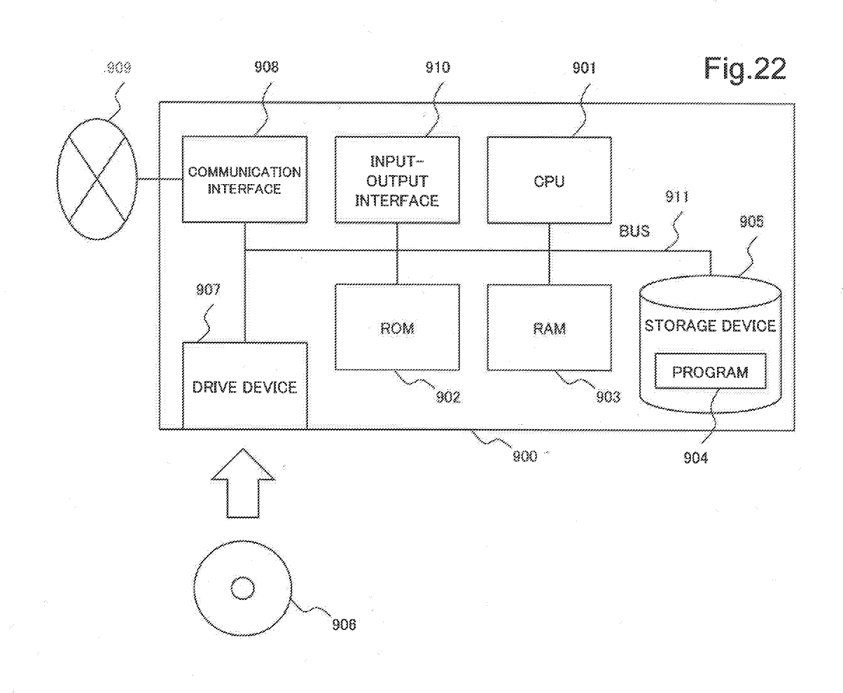

Each component in each of the stock management device, the on-board device, and the customer terminal, according to the respective example embodiments of the present disclosure, represents a functional unit block. For example, each component in each of the stock management device, the on-board device, and the customer terminal is implemented in part or in whole with any combination of an information processing device 900 as illustrated in FIG. 22 and a program. FIG. 22 is a block diagram illustrating a hardware configuration example of the information processing device 900 implementing each component in each of the stock management device, the on-board device, and the customer terminal. As an example, the information processing device 900 includes a configuration as described below.
A central processing unit (CPU) 901
A read only memory (ROM) 902
A random access memory (RAM) 903
A program 904 loaded into the RAM 903
A storage device 905 storing the program 904
A drive device 907 performing reading from and writing to a recording medium 906
A communication interface 908 connected to a communication network 909
An input-output interface 910 performing input and output of data
A bus 911 connecting the respective components

Each component in each of the stock management device, the on-board device, and the customer terminal, according to the respective example embodiments, is implemented by the CPU 901 acquiring and executing the program 904 implementing a function of the component. For example, the program 904 implementing the function of each component in each of the stock management device, the on-board device, and the customer terminal is pre-stored in the storage device 905 or the ROM 902, and is read by the CPU 901 as needed. The program 904 may be provided to the CPU 901 through the communication network 909; or the program may be pre-stored in the recording medium 906, and the drive device 907 may read the program and provide the program to the CPU 901.

There are various modified examples of the implementation method of each of the stock management device, the on-board device, and the customer terminal. For example, each of the stock management device, the on-board device, and the customer terminal may be implemented with any combination of a separate information processing device 900 and a program, for each component. Further, a plurality of components included in each of the stock management device, the on-board device, and the customer terminal may be implemented with any combination of a single information processing device 900 and a program.

Further, each component in each of the stock management device, the on-board device, and the customer terminal is implemented in part or in whole with another general-purpose or dedicated circuit, a processor, or the like, or a combination thereof. The above may be configured with a single chip or may be configured with a plurality of chips connected through a bus.

Each component in each of the stock management device, the on-board device, and the customer terminal may be implemented in part or in whole with a combination of the aforementioned circuit or the like, and a program.

When each component in each of the stock management device, the on-board device, and the customer terminal is implemented in part or in whole with a plurality of information processing devices, circuits, or the like, the plurality of information processing devices, circuits, or the like may be arranged in a concentrated manner or be arranged in a distributed manner. For example, the information processing devices, the circuits, or the like may be implemented in a form of being connected to one another through a communication network, such as a client-server system, a cloud computing system, or the like.

The respective aforementioned example embodiments are preferred example embodiments of the present disclosure, and the scope of the present disclosure is not limited to the respective aforementioned example embodiments; and a person skilled in the art can make example embodiments which include various changes through modifying and substituting the respective aforementioned example embodiments without departing from the spirit and scope of the present disclosure.

The aforementioned example embodiments may also be described in whole or in part as the following supplementary notes but are not limited thereto.

### (Supplementary Note 1)

A stock management device including:

management means for managing stock information about stock of an item held by each of a plurality of mobile sales vehicles;

first reception means for receiving, from each of the plurality of mobile sales vehicles, sales information indicating an item sold at a storefront of the mobile sales vehicle;

second reception means for receiving, from a customer terminal, order information including information about an item ordered based on the stock information transmitted to the customer terminal; and

transmission means for transmitting the order information to the mobile sales vehicle holding the ordered item included in the order information, wherein

the management means updates the stock information based on at least one of the sales information and the order information.

### (Supplementary Note 2)

The stock management device according to Supplementary note 1, wherein

the order information includes delivery address information indicating a delivery address of the item,

the first reception means further receives current position information indicating current positions of the plurality of mobile sales vehicles,

the stock management device further includes specification means for specifying a mobile sales vehicle arriving earliest at the delivery address out of the mobile sales vehicles holding the ordered item, based on a current position of the mobile sales vehicle indicated by the current position information, and a position of the delivery address indicated by the delivery address information, and

the transmission means transmits the order information to the specified mobile sales vehicle.

### (Supplementary Note 3)

The stock management device according to Supplementary note 1 or 2, wherein

the management means updates stock information about stock held by the specified mobile sales vehicle, based on the order information.

### (Supplementary Note 4)

The stock management device according to any one of Supplementary notes 1 to 3, wherein

the transmission means further transmits sellout information indicating that an item held by the mobile sales vehicle is sold out.

### (Supplementary Note 5)

The stock management device according to any one of Supplementary notes 1 to 4, further including:

second transmission means for transmitting the stock information to the customer terminal, wherein

the second transmission means transmits the stock information to the customer terminal after detecting that an operation for purchasing an item is performed by use of the customer terminal.

### (Supplementary Note 6)

The stock management device according to Supplementary note 5, wherein

the second transmission means further transmits the updated stock information to the customer terminal every time the stock information is updated.

### (Supplementary Note 7)

An on-board device being loaded on each of a plurality of mobile sales vehicles, the on-board device including:

reception means for receiving sellout information indicating that an item is sold out, from a stock management device managing stock information about stock of an item held by each of the plurality of mobile sales vehicles, when the item held by the mobile sales vehicle is sold out by an order from a customer terminal for the item held by the mobile sales vehicle; and

notification means for making notification that the item is sold out, based on the sellout information.

### (Supplementary Note 8)

The on-board device according to Supplementary note 7, wherein

the notification means makes notification in an understandable manner for a driver of the mobile sales vehicle that the item is sold out.

### (Supplementary Note 9)

The on-board device according to Supplementary note 7, wherein

the notification means displays a screen indicating that the item is sold out in a visually recognizable manner for a customer using the mobile sales vehicle.

### (Supplementary Note 10)

The on-board device according to Supplementary note 7, further including:

recognition means for recognizing an item of which a customer using the mobile sales vehicle is considering purchase, wherein

the notification means determines whether or not an item recognized by the recognition means is sold out, based on the sellout information, and when determining the item to be sold out, makes notification in an understandable manner for the customer that the item of which the customer is considering purchase is sold out.

### (Supplementary Note 11)

An item sales system including:

a stock management device;

an on-board device being loaded on each of a plurality of mobile sales vehicles and transmitting, to a stock management device, sales information indicating an item sold at a storefront of each of the plurality of mobile sales vehicles; and

one or more customer terminals, wherein

the stock management device includes:
management means for managing stock information about stock of an item held by each of the plurality of mobile sales vehicles;
first reception means for receiving the sales information;
second reception means for receiving, from the customer terminal, order information including information about an item ordered based on the stock information transmitted to the customer terminal; and
transmission means for transmitting the order information to the on-board device on the mobile sales vehicle holding the ordered item included in the order information, wherein

the management means updates the stock information based on at least one of the sales information and the order information.

### (Supplementary Note 12)

The item sales system according to Supplementary note 11, wherein

the order information includes delivery address information indicating a delivery address of the item,

the first reception means further receives current position information indicating current positions of the plurality of mobile sales vehicles,

the stock management device further includes specification means for specifying a mobile sales vehicle arriving earliest at the delivery address out of the mobile sales vehicles holding the ordered item, based on a current position of the mobile sales vehicle indicated by the current position information, and a position of the delivery address indicated by the delivery address information, and

the transmission means transmits the order information to the on-board device on the specified mobile sales vehicle.

### (Supplementary Note 13)

A stock management method including:

managing stock information about stock of an item held by each of a plurality of mobile sales vehicles;

receiving, from each of the plurality of mobile sales vehicles, sales information indicating an item sold at a storefront of the mobile sales vehicle;

receiving, from a customer terminal, order information including information about an item ordered based on the stock information transmitted to the customer terminal; and

transmitting the order information to the mobile sales vehicle holding the ordered item included in the order information, wherein

updating the stock information based on at least one of the sales information and the order information.

### (Supplementary Note 14)

The stock management method according to Supplementary note 13, wherein

the order information includes delivery address information indicating a delivery address of the item,

receiving, by the stock management method, current position information indicating current positions of the plurality of mobile sales vehicles,

specifying a mobile sales vehicle arriving earliest at the delivery address out of the mobile sales vehicles holding the ordered item, based on a current position of the mobile sales vehicle indicated by the current position information, and a position of the delivery address indicated by the delivery address information, and

in the transmitting the order information, transmitting the order information to the specified mobile sales vehicle.

### (Supplementary Note 15)

A notification method in an on-board device being loaded on each of a plurality of mobile sales vehicles, the notification method including:

receiving sellout information indicating that an item is sold out, from a stock management device managing stock information about stock of an item held by each of the plurality of mobile sales vehicles, when the item held by the mobile sales vehicle is sold out by an order from a customer terminal for the item held by the mobile sales vehicle; and

making notification that the item is sold out, based on the sellout information.

### (Supplementary Note 16)

The notification method according to Supplementary note 15, wherein

making notification in an understandable manner for a driver of the mobile sales vehicle that the item is sold out.

### (Supplementary Note 17)

The notification method according to Supplementary note 15, wherein

displaying a screen indicating that the item is sold out in a visually recognizable manner for a customer using the mobile sales vehicle.

### (Supplementary Note 18)

The notification method according to Supplementary note 15, further including:

recognizing an item of which a customer using the mobile sales vehicle is considering purchase, wherein

determining whether or not an item recognized is sold out, based on the sellout information, and when determining the item to be sold out, making notification in an understandable manner for the customer that the item of which the customer is considering purchase is sold out.

### (Supplementary Note 19)

A stock management method in an item sales system including a stock management device, an on-board device loaded on each of a plurality of mobile sales vehicles, and one or more customer terminals, the stock management method including:

managing, by the stock management device, stock information about stock of an item held by each of the plurality of mobile sales vehicles;

transmitting, by the on-board device, to a stock management device, sales information indicating an item sold at a storefront of a mobile sales vehicle loaded with the on-board device;

transmitting, by the customer terminal, to the stock management device, order information including information about an item ordered based on the stock information received from the stock management device;

receiving, by the stock management device, the sales information transmitted from the on-board device;

receiving, by the stock management device, the order information from the customer terminal;

transmitting, by the stock management device, the order information to the on-board device on the mobile sales vehicle holding the ordered item included in the order information; and

updating, by the stock management device, the stock information based on at least one of the sales information and the order information.

### (Supplementary Note 20)

The stock management method according to Supplementary note 19, wherein

the order information includes delivery address information indicating a delivery address of the item, and the stock management method further includes:

further receiving, by the stock management device, current position information indicating current positions of the plurality of mobile sales vehicles;

specifying a mobile sales vehicle arriving earliest at the delivery address out of the mobile sales vehicles holding the ordered item, based on a current position of the mobile sales vehicle indicated by the current position information, and a position of the delivery address indicated by the delivery address information; and

transmitting the order information to the specified mobile sales vehicle in transmission of the order information.

### (Supplementary Note 21)

A non-transitory computer readable storage medium storing a program that causes a computer to execute:

a process of managing stock information about stock of an item held by each of a plurality of mobile sales vehicles;

a process of receiving, from each of the plurality of mobile sales vehicles, sales information indicating an item sold at a storefront of the mobile sales vehicle;

a process of receiving, from a customer terminal, order information including information about an item ordered based on the stock information transmitted to the customer terminal; and

a process of transmitting the order information to the mobile sales vehicle holding the ordered item included in the order information, wherein

a process of updating the stock information based on at least one of the sales information and the order information.

### (Supplementary Note 22)

The storage medium according to Supplementary note 21, wherein

the order information includes delivery address information indicating a delivery address of the item,

the program causes the computer to execute:

a process of receiving current position information indicating current positions of the plurality of mobile sales vehicles,

a process of specifying a mobile sales vehicle arriving earliest at the delivery address out of the mobile sales vehicles holding the ordered item, based on a current position of the mobile sales vehicle indicated by the current position information, and a position of the delivery address indicated by the delivery address information, wherein

the process of transmitting the order information is a process of transmitting the order information to the specified mobile sales vehicle.

### (Supplementary Note 23)

A non-transitory computer readable storage medium storing a program that causes a computer to execute:

a process of receiving sellout information indicating that an item is sold out, from a stock management device managing stock information about stock of an item held by each of the plurality of mobile sales vehicles, when the item held by the mobile sales vehicle is sold out by an order from a customer terminal for the item held by the mobile sales vehicle; and

a process of making notification that the item is sold out, based on the sellout information.

### (Supplementary Note 24)

The storage medium according to Supplementary note 23, wherein

the process of making notification in an understandable manner for a driver of the mobile sales vehicle that the item is sold out.

### (Supplementary Note 25)

The storage medium according to Supplementary note 23, wherein

the process of making notification is a process of displaying a screen indicating that the item is sold out in a visually recognizable manner for a customer using the mobile sales vehicle.

### (Supplementary Note 26)

The storage medium according to Supplementary note 23, wherein storing a program for causing the computer to further perform:

a process of recognizing an item of which a customer using the mobile sales vehicle is considering purchase, wherein

the process of making notification is a process of determining whether or not an item recognized is sold out, based on the sellout information, and when determining the item to be sold out, and making notification in an understandable manner for the customer that the item of which the customer is considering purchase is sold out.

This application claims priority based on Japanese Patent Application No. 2016-162552 filed on Aug. 23, 2016, the disclosure of which is hereby incorporated by reference thereto in its entirety.

### REFERENCE SIGNS LIST

1 Item sales system
2 Item sales system
10 Stock management device
11 Management unit
12 First reception unit
13 Second reception unit
14 Transmission unit
20 On-board device
30 Customer terminal
100 Stock management device
110 Management unit
120 First reception unit
130 Second reception unit
140 First transmission unit
150 Second transmission unit
160 Stock information storage unit
170 Customer information storage unit
180 Specification unit
200 On-board device
201 On-board device
202 On-board device
210 Sales information acceptance unit
220 Transmission unit
230 Positioning unit
240 Reception unit
211 Reception unit
221 Notification unit
212 Recognition unit
300 Customer terminal
310 Reception unit
320 Control unit
330 Display unit
340 Acceptance unit
350 Transmission unit

What is claimed is:

1. A stock management device comprising:
a memory storing instructions; and
one or more processors configured to execute the instructions to:
manage stock information about stock of an item held by each of a plurality of mobile sales vehicles;
receive, from each of the plurality of mobile sales vehicles, sales information indicating an item sold at a storefront of the mobile sales vehicle;
receive, from a customer terminal, order information including information about an item ordered based on the stock information transmitted to the customer terminal; and
transmit the order information to the mobile sales vehicle holding the ordered item included in the order information, wherein
the one or more processors are further configured to execute the instructions to:
update the stock information based on at least one of the sales information and the order information.

2. The stock management device according to claim 1, wherein
the order information includes delivery address information indicating a delivery address of the item,
the one or more processors are further configured to execute the instructions to:
receive current position information indicating current positions of the plurality of mobile sales vehicles,
specify a mobile sales vehicle arriving earliest at the delivery address out of the mobile sales vehicles holding the ordered item, based on a current position of the mobile sales vehicle indicated by the current position information, and a position of the delivery address indicated by the delivery address information, and
transmit the order information to the specified mobile sales vehicle.

3. The stock management device according to claim 1, wherein
the one or more processors are further configured to execute the instructions to:
update stock information about stock held by the specified mobile sales vehicle, based on the order information.

4. The stock management device according to claim 1, wherein
the one or more processors are further configured to execute the instructions to:
transmit sellout information indicating that an item held by the mobile sales vehicle is sold out.

5. The stock management device according to claim 1, wherein:
the one or more processors are further configured to execute the instructions to:
transmit the stock information to the customer terminal, and
transmit the stock information to the customer terminal after detecting that an operation for purchasing an item is performed by use of the customer terminal.

6. The stock management device according to claim 5, wherein
the one or more processors are further configured to execute the instructions to:
transmit the updated stock information to the customer terminal every time the stock information is updated.

7. An on-board device being loaded on each of a plurality of mobile sales vehicles, the on-board device comprising:
a memory storing instructions; and
one or more processors configured to execute the instructions to:
receive sellout information indicating that an item is sold out, from a stock management device managing stock information about stock of an item held by each of the plurality of mobile sales vehicles, when the item held by the mobile sales vehicle is sold out by an order from a customer terminal for the item held by the mobile sales vehicle; and
make notification that the item is sold out, based on the sellout information.

8. The on-board device according to claim 7, wherein
the one or more processors are further configured to execute the instructions to:
make notification in an understandable manner for a driver of the mobile sales vehicle that the item is sold out.

9. The on-board device according to claim 7, wherein
the one or more processors are further configured to execute the instructions to:
display a screen indicating that the item is sold out in a visually recognizable manner for a customer using the mobile sales vehicle.

10. The on-board device according to claim 7, wherein
the one or more processors are further configured to execute the instructions to:
recognize an item of which a customer using the mobile sales vehicle is considering purchase, wherein
determine whether or not an item recognized is sold out, based on the sellout information, and when determining the item to be sold out, makes notification in an understandable manner for the customer that the item of which the customer is considering purchase is sold out.

11-12. (canceled)

13. A stock management method comprising:
managing stock information about stock of an item held by each of a plurality of mobile sales vehicles;
receiving, from each of the plurality of mobile sales vehicles, sales information indicating an item sold at a storefront of the mobile sales vehicle;
receiving, from a customer terminal, order information including information about an item ordered based on the stock information transmitted to the customer terminal; and
transmitting the order information to the mobile sales vehicle holding the ordered item included in the order information, wherein
updating the stock information based on at least one of the sales information and the order information.

14. The stock management method according to claim 13, wherein
the order information includes delivery address information indicating a delivery address of the item,
receiving, by the stock management method, current position information indicating current positions of the plurality of mobile sales vehicles,
specifying a mobile sales vehicle arriving earliest at the delivery address out of the mobile sales vehicles holding the ordered item, based on a current position of the mobile sales vehicle indicated by the current position information, and a position of the delivery address indicated by the delivery address information, and
in the transmitting the order information, transmitting the order information to the specified mobile sales vehicle.

15-26. (canceled)
